(19) United States
(12) Patent Application Publication
(10) Pub. No.: US 2002/0147652 A1
(43) Pub. Date: Oct. 10, 2002

(54) System and method for distruibuted client state management across a plurality of server computers

(76) Inventors: Ahmed Gheith, Round Rock, TX (US); Rod Mancisidor, Austin, TX (US)

Correspondence Address: GRAY, CARY, WARE & FREIDENRICH LLP, 1221 SOUTH MOPAC EXPRESSWAY, SUITE 400, AUSTIN, TX, 78746-6875, US

(21) Appl. No.: 09/764,662

(22) Filed: Jan. 18, 2001

Related U.S. Application Data
(60) Provisional application No. 60/241,541, filed on Oct. 18, 2000.

(51) Int. Cl. G06F 17/60

(52) U.S. Cl. 705/26; 705/80

(57) ABSTRACT

A system and method maintains session states in a plurality of server computers forming a server computer group. Upon an initial customer access of a first server computer of the server computer group, a first server computer creates a session state for the customer. The first server computer then transmits a command to the other server computers in the server computer group that cause the customer's session state to be created on the other server computers of the server computer group. Session states are stored in the dynamic or static memory of the server computers of the server computer group. Session state updates are made in the computer servers via broadcasted commands. On a subsequent access of the server computer group, the customer may access a different server computer of the server computer group. Upon this access, the customer computer provides the session state ID to the different server computer. The different server computer, which possesses a copy of the session state, accesses its copy of the session state using the FactID and services the customer query. If it does not possess a copy, it requests a copy from another computer server.

CROSS-REFERENCE TO RELATED APPLICATION

The present application claims priority pursuant to 35 U.S.C. Sec. 119(e) to U.S. Provisional Application Serial No. 60/241,541, filed Oct. 18, 2000, pending, which is hereby incorporated herein by reference in its entirety.

### BACKGROUND

1. Technical Field

The present invention relates generally to electronic commerce across the Internet; and more particularly to the management of customer session state in a system wherein the customer may access any of a plurality of server computers.

2. Related Art

The popularity and use of the Internet (World-Wide-Web “WWW”) continues to increase dramatically. While electronic commerce (e-commerce) across the Internet is a relatively recent development, e-commerce sales already represent a substantial portion of overall sales. Some e-commerce sellers sell only via the Internet, other e-commerce sellers maintain conventional stores and sell over the Internet as well. Because e-commerce sales can be serviced using only computer equipment without a storefront of sales personnel, the cost of each serviced transaction is extremely low as compared to traditional sales methods.

In a typical e-commerce system, an e-commerce seller maintains a plurality of web server computers, each of which may be accessed via the Internet. A customer then accesses one of these web server computers using a customer computer and a computer network, such as the WWW/Internet. The customer is able to access the server computer using a Uniform Resource Locator (URL) associated with the web server computer. The customer may receive the URL from an advertisement, from a web search, from a referring web page, or from another source. The customer's computer then initiates a query to the web server computer using the URL by first accessing a serving Domain Name Server (DNS). The DNS returns an IP address corresponding to one of the plurality of web server computers.

The customer computer then receives the IP address from the DNS and initiates a query to the web server computer. This query includes not only the IP address of the web server computer but also includes the IP address of the customer computer and other information contained in the URL accessed by the customer, e.g., the address of a particular page requested, query options, additional customer/client data, referring web page ID, etc. Upon receipt of the query from the customer computer, the web server computer services the request and returns content to the customer computer.

In servicing the query, the web server computer establishes or updates a session state that includes information relating to the customer's visit to the web server computer. Upon a first visit to the web server computer, the web server computer establishes the session state and inputs thereto a history of the first visit, e.g., content requested, content delivered, shopping cart contents, etc. Upon subsequent queries to the web server computer, the web server computer retrieves the session state and updates the session state according to the activities performed for the current query.

When an e-commerce site uses only a single web server computer, the single web server computer may easily track the session state of the accessing customer. However, most e-commerce sites employ a plurality of web server computers organized as a server computer farm. With this server computer farm architecture, any of the web server computers may service any particular customer query. Customer queries are typically distributed to the plurality of web server computers by a load-balancing server computer or by operation of the DNS. Thus, a web server computer that has previously serviced a customer query may not service the customer's subsequent query. Likewise, a web server computer that did not service a previous customer query may service a current customer query. Thus, a servicing web server computer may not possess a current copy of the customer's session state.

In response to the problem of having a current session state available to a serving web server computer, various solutions have been resulted. Under one solution, all session states are written to a central server computer, file system, or database that is accessible to all web server computers. When a web server computer receives a query from a customer, the web server computer accesses the central server computer, file system, or database to retrieve the session state of the customer. Upon receipt of the session state, the web server computer may then correctly operate upon the customer query. Because this solution is centralized and subject to the limitations of a centralized resource, this solution does not provide high availability and is susceptible to a single point of failure. Further, because a session state access may be required for each customer query, this solution results in significant delays in providing current session states, such delay oftentimes resulting in a browser time-out presentation to the customer or a message to the customer stating that the session has timed-out.

Another solution to the problem of session state management is to attach the session state to URLs in web pages or other content returned to the customer computer. Then, when the customer clicks on a corresponding link within the returned web page, the session state will be returned to the web server computer. With this solution, therefore, none of the web server computers is required to store the session state for the customer. However, with this solution, if the customer does not return to the e-commerce site directly from the most current web page provided, the correct session state will not be returned. For example, a customer may fill his or her shopping cart, move to another page to check stock quotes, and then revisit the e-commerce site by inputting the URL of the e-commerce site. Upon the customer's return, a servicing web server computer will have no knowledge of the session state. Further, with this solution, if a customer goes back a few web pages and clicks on a link associated with an earlier session state, the earlier and incorrect session state will be returned to the web server computer.

Thus, there is a need in the art for a system and method that efficiently manages customer session state in an efficient, accurate and effect manner that may be employed in a multiple server computer environment.

### SUMMARY OF THE INVENTION

Thus, to overcome the shortcomings of the prior systems and methods in managing customer session state, a system and method constructed according to the present invention maintains session states in a plurality of server computers forming a server computer group, any of which may service the customer's queries. Upon an initial customer access of a first server computer of the server computer group, a first server computer creates a session state for the customer. The first server computer then transmits a command to the other server computers in the server computer group that cause the customer's session state to be created on the other server computers of the server computer group. This transmission is in the form of a broadcast or a multicast. Other of the server computers that receive the transmission store the session state in their memory or upon other of their storage devices, e.g., hard disk, etc. Thus, after this transmission, the customer's session state exists on other of the server computers of the server computer group.

In responding to a query for the session state from a user/customer, the first server computer provides a session state ID (FactID) to the customer's computer. The FactID may be stored on a cookie present in the customer computer. The FactID may also be contained in one or more URLs of a web page or other content provided to the customer computer in response to the query. On a subsequent access of the server computer group, the customer may access a different server computer of the server computer group. Upon this access, the customer computer provides the FactID to the different server computer. The different server computer, which possesses a copy of the session state, accesses its copy of the session state using the FactID and services the customer query.

If the different server computer makes changes to the session state, the different server computer then transmits these changes to the other server computers of the plurality of server computers. The server computers that receive these changes will then update their copy of the session state. In other operations, a system server computer may delete a session state, create a new session state for the customer, renew a session state (if the session state is soon to expire), and otherwise alter the session state. Upon executing these operations, the server computer then transmits these changes to the other server computers so that they may also update their copies of the session state.

In some operations, all session states will not be present on every server computer on the plurality of server computers. When a server computer receives a query from a customer containing a FactID, the server computer first accesses the session states it stores locally. If the session state is not present, the server computer then broadcasts a request for the session state, the request including the FactID. In response to this request, another of the server computers returns a copy of the session state to the requesting server computer for use in servicing the query. The requesting server computer then services the customer request and may modify the session state accordingly.

Maintaining copies of session states on each server computer decreases time to retrieval for any servicing server computer. When the session state is stored in the memory of the server computer, a minimal access time is provided. Further, because copies of the session states are included on a plurality of server computers, no single point of failure exists. Moreover, any of the server computers may be taken out of service without a loss of system state. When the server computers are coupled by a local area network (LAN) or other high-speed coupling network, the transmission of session states among server computers occurs rapidly and with great dispatch. However, even when the server computers are coupled via the Internet or another, lesser throughput network, the benefits provided by the present invention still greatly exceed the costs associated therewith. Moreover, other aspects of the present invention will become apparent with further reference to the drawings and specification, which follow.

### BRIEF DESCRIPTION OF THE DRAWINGS

A better understanding of the present invention can be obtained when the following detailed description of the preferred embodiment is considered in conjunction with the following drawings, in which:

FIG. 1 is a diagram illustrating a system for supporting agent assisted and customer specific e-commerce constructed according to the present invention;

FIG. 2 is a diagram illustrating a particular embodiment of a system constructed according to the present invention;

FIG. 3 is a block diagram illustrating functional components of computer server computer employed to accomplish the teachings of the present invention;

FIG. 4 is a block diagram generally illustrating one embodiment of a site template constructed according to the present invention;

FIG. 5 is a block diagram generally illustrating one embodiment of a personality file constructed according to the present invention;

FIG. 6 is a block diagram illustrating components of the system of the present invention involved in operating upon a system state according to the present invention;

FIG. 7A is a block diagram illustrating components of the system of the present invention involved in the selection of products and services;

FIGS. 7B-7F are block diagrams illustrating components used in the selection of products and services according to the present invention;

FIG. 8 is a block diagram illustrating a content creation and management server computer constructed according to the present invention;

FIG. 9 is a system diagram illustrating a system constructed according to the present invention in which session states are maintained on all server computers forming a server computer farm;

FIG. 10 is a system diagram illustrating an alternate construction of a system according to the present invention in which session states are maintained on all server computers forming groups of server computer farms;

FIG. 11A is a block diagram illustrating the structure of a Fact ID that serves to identify a session state (or component thereof) managed by the systems of FIGS. 9 and 10;

FIG. 11B is a block diagram illustrating the structure of a Fact Array, a Fact Container and other structures that may be included within or reference by entries in the Fact Array;

FIG. 12 is a block diagram illustrating the architecture of one embodiment of the Grapevine Protocol constructed according to the present invention;

FIGS. 13 and 14 are logic diagrams generally illustrating operations according to the present invention in managing session states across a plurality of server computers;

FIG. 15 is a logic diagram illustrating operation according to the present invention in publishing facts contained in a fact array to other server computers;

FIG. 16 is a logic diagram illustrating operation according to the present invention in servicing a request for a Fact from another process operating upon a server computer;

FIG. 17 is a logic diagram illustrating operation according to the present invention in servicing communications received at a broadcast port; and

FIG. 18 is a logic diagram illustrating operation according to the present invention in performing garbage collection of the FactArray.

### DETAILED DESCRIPTION OF THE DRAWINGS

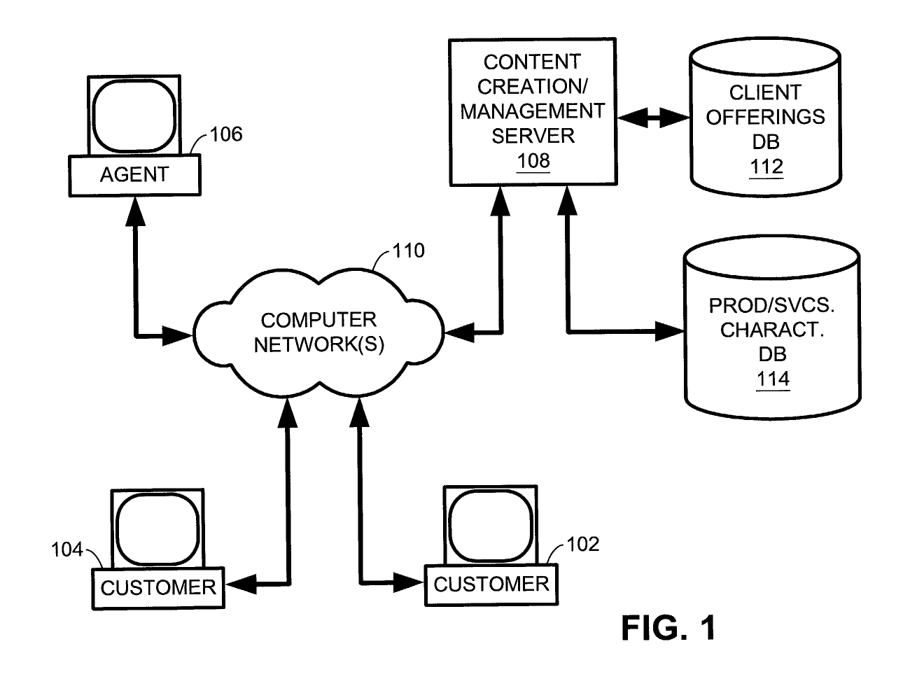

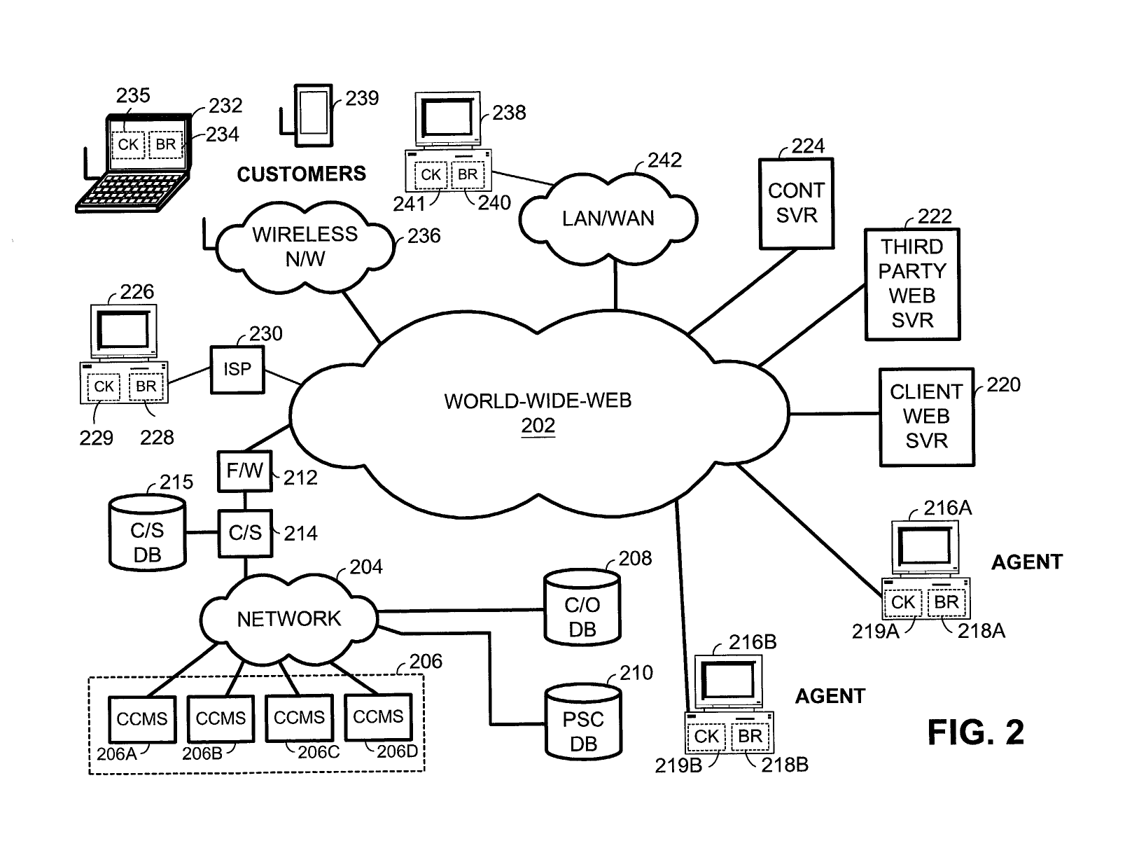

FIG. 1 is a diagram illustrating a system for supporting agent assisted and customer specific e-commerce constructed according to the present invention. The web-based system includes at least one content creation and management server computer (CCMS) 108, a client offerings database (C/O DB) 112, and a product/services capabilities (PSC DB) database (PSC DB) 114. The CCMS 108, C/O DB 112, and PSC DB 114 communicate with customers 102 and 104 and agent 106 via computer network(s) 110. The computer network(s) 110 are made up of one or more interconnected computer networks that allow the various components and entities to communicate there between. Customers 102 and 104 and agent 106 access the system using computer terminals. These computer terminals are referenced generally as desktop personal computer symbols in FIG. 1. However, as will be further described with reference to FIG. 2, the devices used by the customers and agents may be devices other than desktop person computers.

A client is an entity or individual, e.g., corporation, partnership, individual, etc. that is engaged in commerce and that has products or services to sell. Clients may be engaged in e-commerce, traditional commerce or may be engaged in both e-commerce and traditional commerce. As is contemplated herein, customers 102 and 104 have difficulty in selecting products/services offered by clients due to the complexity in the types of products/services offered and due to the number of clients offering the products/services. Because of the difficulty in selecting appropriate products and services, the agent 106 “assists” in the selection process.

In most situations, the customers 102 and 104 secure the services of the agent 106 prior to commencing the selection process. In such case, customer 102, for example, recognizes the need to obtain a produce or service but also recognizes the difficulty in selecting such product or service. Based upon this need then, the customer 102 secures the services of the agent 106, the agent 106 directs the customer 102 to the CCMS 108 for product or service selection. The CCMS 108 then services the selection process with the agent's 106 intervention. In other situations, the agent 106 may be assigned to the customer 102 when the selection process commences. In such case, no prior relationship existed between the agent 106 and the client 102.

An operational example that will be referred to frequently herein involves the selection of communication services. The customer 102 has a unique set of communication requirements and cost constraints. Each service offering has its own unique set of communication characteristics. Further, each client has its own service offerings, its own pricing structures, and its own availability constraints. The customer 102 must select appropriate communication service(s) from appropriate client(s) to service its communication requirements. In selecting these communication services, the customer 102 must consider his own communication requirements and his own cost constraints in selecting particular communication service(s) from particular client(s). This selection process is technologically difficult, complicated and requires assistance by the agent 106.

According to the present invention, the agent 106 assists the customer 102 in selecting appropriate communication service(s) from appropriate client(s). In assisting the customer 102, the agent 106 creates a web site on the CCMS 108 that is subsequently serviced by the CCMS 108. This web site is unique to the agent 106 and may be unique to the customer 102. Once the agent 106 creates the web site, the customers 102 access the web site and use the web site in the selection of one or more communication services. In this same manner, the agent 106 may create a web site that is unique to customer 104, and other web sites that are unique to other customers.

In creating the web site that is unique to a customer, customer 102, the agent 106 determines the content that will be viewed by the customer 102, the information that will be required from the customer 102, the types of communication services that are available to the customer 102, and the clients that are available to the customer 102. If the agent 106 represents a partial set of the clients, the agent 106 may limit client offerings to those clients that he or she represents, for example.

As will be further described herein, the agent 106 sets up the web site with a set of site templates and a personality file. The set of site templates provides framework with which web pages are created. The personality file includes elements that bind presentation content and executables to places in the site templates. Thus, the combination of a set of site templates and the personality file defines a set of web pages. The customer 102 then is able to access any of these sets of web pages upon visiting the agent's 106 web site hosted by the CCMS 106.

Because the web site is created by, and tailored to the preferences of the agent 106, the web site has the personality of the agent 106. The agent 106 may tailor the complexity of the web site to the customer's 102 level of understanding. If the customer 102 is technically competent in the communications area, for example, the agent 106 will elicit technically detailed information. However, if the customer 102 is technically challenged, the agent 106 will elicit more general information from the customer 102. The level of detail of information presented may also be tailored to the level of understanding of the customer 102.

According to the present invention, the agent 106 may setup a plurality of web sites, each of which is tailored to a particular customer type, e.g., individual, small business, medium business, and large business. Then, the agent 106 will direct each of his or her clients to the corresponding web site type. Each of the web sites will include some common components and some components that are tailored to the particular web site. Information presented and questions posed to the customers will be tailored to the type of customer who is directed to the site.

In a similar manner the content of the sites may be based upon commonalities. For example, if an agency or client employs a number of agents, the web site may be first tailored to the agency, next to a particular group of agents, then to the particular agent, and finally to a particular set of customers or to an individual customer. Such a structure may be according to a hierarchy, wherein a top level of the hierarchy represents the agency, a next lower level represents a particular group of agents, a next lower level represents a particular agent, and a next lower level represents particular customers serviced by the agent.

The CCMS 108 assists the customers 102 and 104 in making their selections by using information regarding the communication services that it retrieves from the PSC DB 114. These service capabilities were previously compiled and are stored so that they may be retrieved and used in the selection process. Types of service capabilities for this particular communication services include, for example, the bandwidth obtainable with DSL service, ISDN service, cable modem service, etc., the difficulty in setting up the service, the privacy characteristics of same, the equipment costs associated with the service, an approximate number of customers that the service could support, and other relevant information. The service capability information is used in attempting to determine which service(s) would adequately meet the communication requirements of the particular customer 102 or 104.

The CCMS 108 also uses information relating to the client offerings in assisting the customers 102 and 104 in making their selections. These offerings were also previously complied and are stored in the C/O DB 112. As was previously discussed, the contents of the C/O DB 112 may be limited according to the preferences of the agent 106, e.g., the agent 106 limits the clients from which the customer 102 may obtain service.

The CCMS 108 can therefore service a plurality of agents and provide a unique web site for each agent. Further, the CCMS 108 is capable of providing a unique web site for each customer, each unique web site setup by a servicing agent. In this fashion, the CCMS 108 is unseen by the customer and the web site visited by the customer appears to be the agent's alone.

According to one aspect of the present invention, the state (including a plurality of state components) of a customer's visit to the CCMS 108 is maintained on the customer's computer (102 or 104). During each communication with the CCMS 108, state components are passed back and forth between the customer computer 102 and the CCMS 108. Thus, the state of the current session may be passed to the CCMS 108 without requiring that the CCMS 108 keep track of the customer's state. By offloading the requirement of state maintenance at the CCMS 108, significant advantages can be obtained via quicker CCMS 108 accesses, scalability, and simplicity in operation.

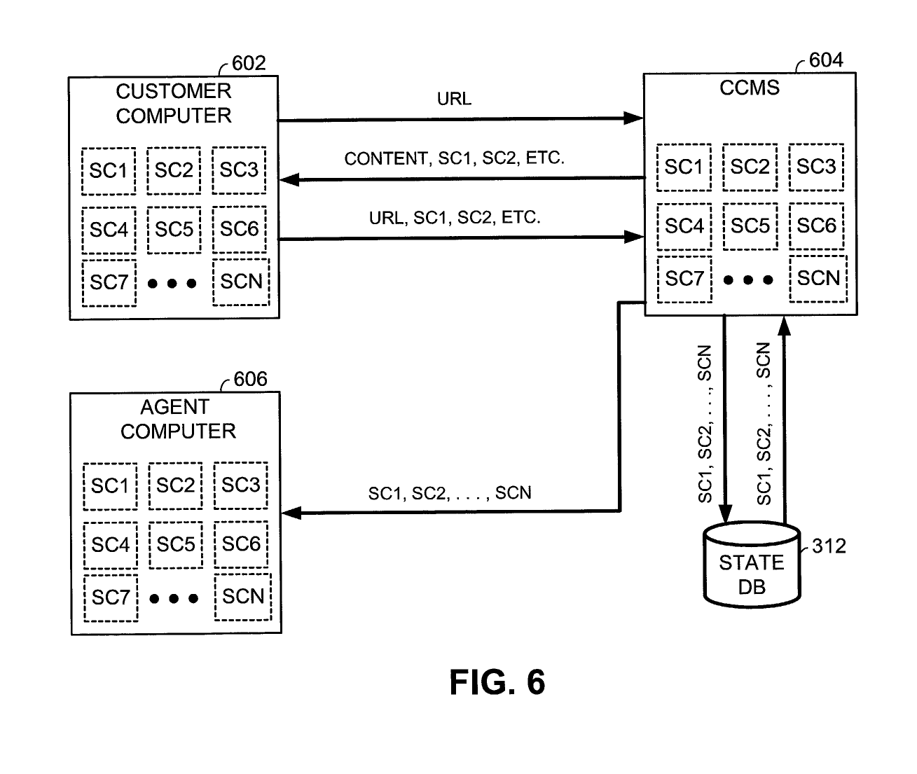

According to another aspect of the present invention, the state of a customer's session may be saved to a state database by the CCMS 108 upon request of the customer 102. In one operation, the state is saved so that the agent 106 may collaborate in the product/service selection process. In performing this collaboration, the agent 106 working with the customer logs in to the CCMS 108, retrieves the customer's state, analyzes the customer's selections, provides feedback to the customer regarding the session, answers customer questions in the session and, when complete, saves the customer's state in the state database. The customer may then resume the session from the point that the agent 106 ceased the collaboration. Thus, the state saving and retrieval operations allow the agent 106 to collaborate in the product/service selection process with the customer. Operations with relevance to customer state will be discussed in more detail with reference to FIG. 6.

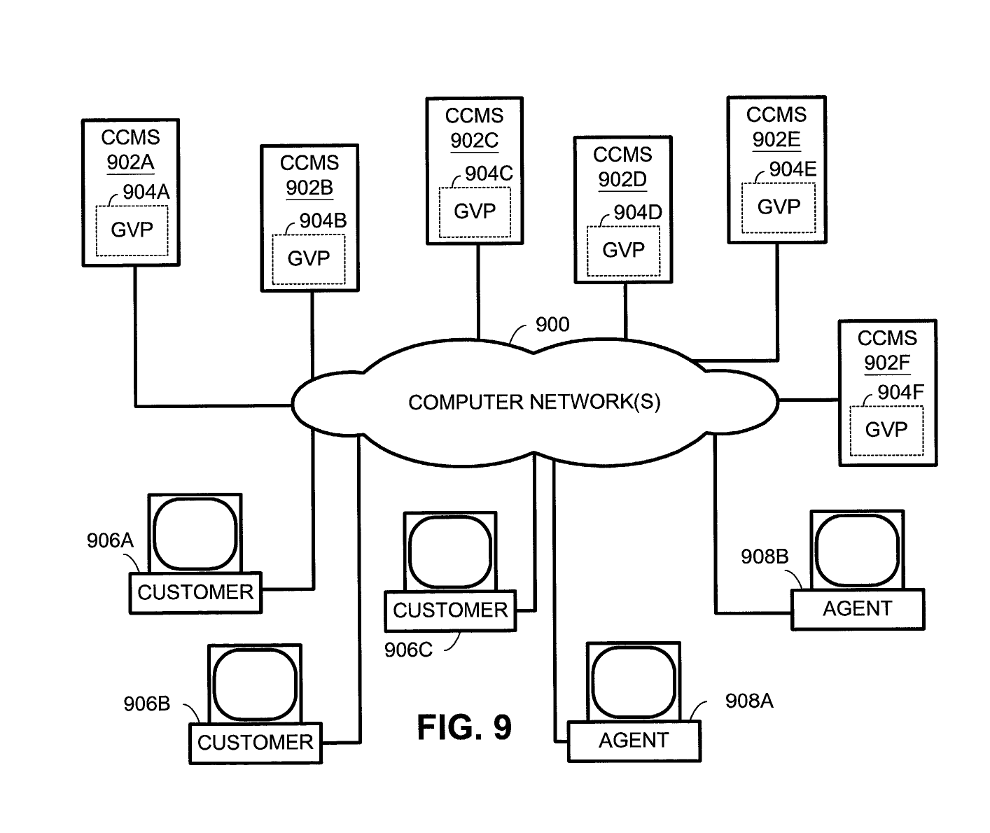

In lieu of the previously described methodologies for managing session states, the “grapevine protocol” may be enacted to manage session states. With the grapevine protocol, session states are neither stored on the customer computer or in a state database but are stored on each of a plurality of server computers performing the functions of the CCMS 108. As will be further described with reference to FIGS. 9 through 13, a plurality of server computers forming at least one server computer farm perform the functions of the CCMS 108. In such case, different CCMSs will service a single customer. Thus, copies of the customer's session state are stored on all, or a substantial portion of the CCMSs. Session state retrieval times using this session state management methodology is significantly reduced.

FIG. 2 is a diagram illustrating a particular embodiment of a system constructed according to the present invention. In the illustrated embodiment, a plurality of CCMSs 206A, 206B, 206C and 206D, collectively 206, couple to the Internet/world-wide-web (WWW) 202 via a local network 204, a cache server computer 214 and a firewall 212. A cache server computer database 215 couples to the cache server computer 214. The C/O DB 208 and the PSC DB 210 also couple to the local network to service the CCMSs 206. A content management interface server computer 212 couples to the personalization/segmentation database 210.

Third party web server computer 222, client web server computer 220 and content server computer 224 also couple to the WWW 202. These server computers, as well as the other server computers, may be at any physical location. Agents 216A and 216B also couple to the WWW 202 and may be located at any physical location. Customers may couple to the CCMSs 206 in any of a variety of manners and reside at any physical location. For example, customer computer 226 running browser 228 and having cookies 229 loaded thereon may couple to the WWW 202 via an Internet service provider 230. Customer computer 238 running browser 240 and having cookies 241 loaded thereon may couple to the WWW 202 via a Local Area Network or Wide Area Network 242. Moreover, customer computer 232 running browser 234 and having cookie 235 loaded thereon may couple to the WWW 202 via a wireless network 236. A customer computer may be another type of electronic device as well that can access the WWW 202 and that is capable of interfacing with the CCMSs 206 (or one of them). Thus, the customer computer could be a personal data assistant 239, an Internet enabled telephone (not shown), a web enabled television (not shown), or another Internet enabled device.

The cookies 229, 235 and 241 located on the customer computers 226, 234 and 238, respectively, operate to store customer state information. The state information in the described embodiment includes a plurality of state components. Agent computers 216A and 216B also run browser software 218A and 218B and include cookies 219A and 219B. These cookies store state components when the agents collaborate with the customer's selection process by retrieving a stored customer state.

Depending upon the type of customer computer employed by the customer, the overall communication link character, connection topology, and other communication link characteristics will differ. However, generally speaking, the customer computer accesses a CCMS 206A, for example, to access the web site of his or her agent. The CCMS 206A services the access to assisting the customer in selecting product(s)/service(s).

The structure illustrated with reference to FIG. 2 is one particular embodiment of the present invention. Various other embodiments may be constructed without departing from the principles of the present invention. For example, each of the CCMSs 206A-206D could couple to the WWW 202, be physically remote from one another, or could directly couple to the D/O DB 208 and PSC DB 210, for example.

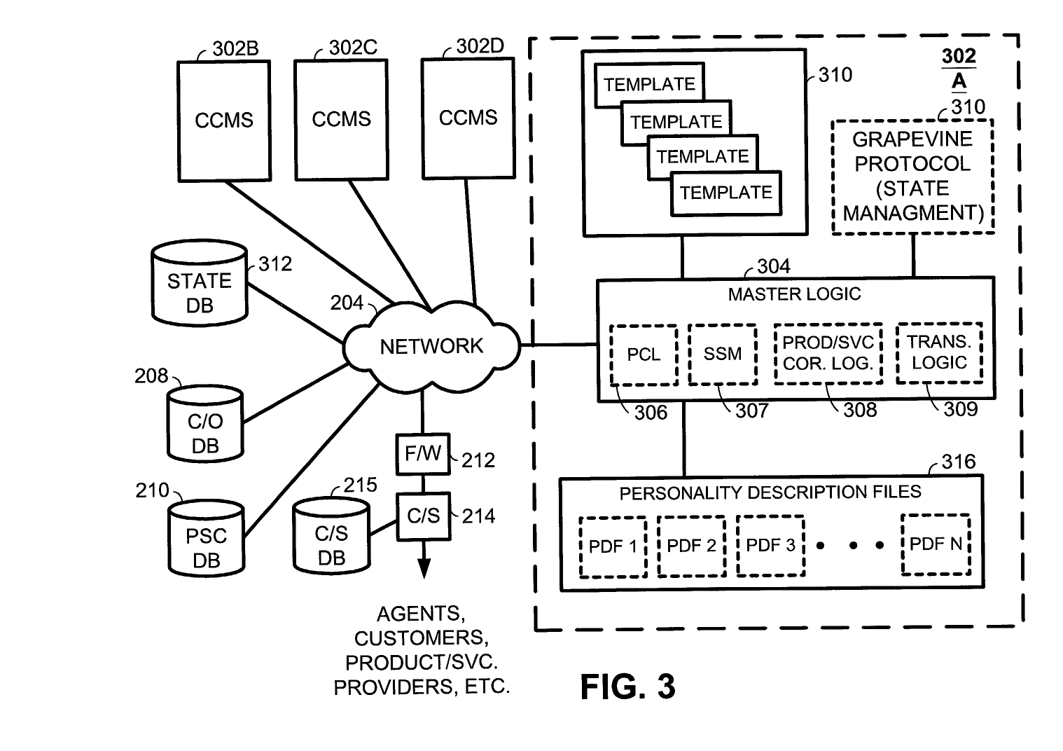

FIG. 3 is a block diagram illustrating functional components of computer server computer employed to accomplish the teachings of the present invention. As is shown, CCMSs 302A, 302B, 302C and 302D couple to network 204. A state database 312, the C/O DB 208 and the PSC DB 210 also couple to the network 204. Further, the network 204 couples to agents, customers, product/service providers, and other resources via a firewall 212 and a cache server computer 214, which couples to the cache server computer database 215.

The CCMS 302A includes a number of functional components, some of which are shown in FIG. 3. In particular, the CCMS 302A includes master logic 304, site templates 310, and personality description files 316. The master logic includes page creation logic (PCL) 306, a state session manager (SSM) 307, product/services correlation logic (PSCL) 308, and transaction logic 309.

The personality description files 316 include personality description file 1 (PDF1), PDF2, PDF3, . . . , PDF N, each of which defines a unique personality that defines a web site. Each PDF may correspond to a particular customer, a set of customers, a particular agent, a set of agents, an agency, or another group of persons/entities.

In one embodiment, each CCMS 302A through 302D also includes the grapevine protocol. The grapevine protocol is a set of operations organized as a protocol that are employed to manage the session states of the customers and agents. As will be further discussed with reference to FIGS. 9 through 13, the grapevine protocol provides a mechanism for each CCMS 302A to 302D to maintain a copy of each customer and/or agent session state. With these operations in place, any customer or agent may access any CCMS 302A to 302D without requiring the customer or agent to store its session state and further without delay in servicing the corresponding request.

Upon an access of the CCMS 302A with a particular URL, the PCL 306 accesses a corresponding PDF, creates a web page based thereupon, and returns the web page to the requesting customer. In creating the web page, the PCL 306 accesses one of the site templates 310 and the corresponding PDF. This architecture isolates the presentation of web-based applications from both the application's logic and the application-specific presentation content. Included is a mechanism for specifying (and implementing) the bindings between them.

The PCL 306 (as well as the SSM 307, the product/services correlation logic 308 and the transaction logic 309) is written in Java. The presentation of the PDF is specified in JSP. This includes the generic “look and feel” components (site templates 310) as well as the specific presentation content. The site templates 310 can be thought of as generic containers for the layout of web pages. Each site template 310 has one area where a specific target presentation content that is obtained from a PDF is inserted. The site templates are generic page layouts, described using JavaServer Pages (JSP). The Site-Templates contain JSP directives that dynamically react to the actual target content being presented (the Place's presentation content). A small set of these page layouts is sufficient for presenting most, if not all, of the business logic.

The bindings between specific presentation content and site templates are made through a set of descriptions that appear in the corresponding PDF file. This information describes Places, which (among other things) map presentation content to site templates. The specific business logic components, and their relationship to a specific site template is described in the PDF file (every personality has its own.) There are several element types in the PDF (XML) file, but the most significant one describes a Place.

There are two types of Places in the PDFs: those that describe logic (a ‘Class’ Place), and those that describe presentation content (a ‘Presentation’ Place).

The description of both types of Places includes:

1. A list of all state components that must exist to execute the Place (e.g. a userid)

2. Any state components that must exist for a menu generator to make this Place visible (e.g. a Shopping Cart)

3. Preconditions (specific component attributes) that must be satisfied before the Place can be executed and/or made visible (e.g. UserRole=Administrator.)

This particular architecture allows:

preconditions to be specified outside of the underlying logic.

component creation, and associated error reporting, to be handled in a common way.

caching of dynamic pages (see below.)

In addition, each Presentation Place describes:

1. A specific presentation component (e.g. the name of a ‘jsp’ page)

2. A specific site-template

Likewise, Class Place descriptions also include:

1. A java class name. (An instance of which will have its dolt method invoked with URL arguments/values.)

2. (Optionally) the name of the next Place to be invoked (most likely a Presentation Place.)

3. All state components upon which the behavior of the class depends (this enables caching of dynamic content.)

All web pages delivered to a customer computer are constructed such that embedded URLs contain a personality name and a target place name. When a request reaches the CCMS 302A, the target place name is used to locate the Place description in the corresponding PDF file for the specified personality. For Presentation Places, the Place is used to combine the target Place's presentation logic with the specified site template. For Class Places, the Place's specified class in ‘invoked’.

This approach has several benefits:

1. The creator of the presentation content is not concerned with how the ‘whole’ page is to appear.

2. Any number of site templates can be created, and any one can be used to “host” some presentation content.

3. The look/feel of the system can be controlled/modified without concern for the business logic or the application content.

Menu navigation is accomplished by making the HREF URL's target place parameter name a Presentation Place. When the request is received, the Place's presentation content (Target JSP page) is identified and the specified site-template is “included.” When the area reserved for the application presentation content in the site template is processed, its logic causes the Target JSP page to be included.

For example, assume the Presentation Place ‘login’ binds the Target JSP Page ‘Login.jsp’ to the site template “Header_Content_Footer.jsp:”

<place id=“login” content=“Login.jsp” type=“jsp” template=“Header_Content_Footer.jsp/>

Any pages sent to the customer computer browser that include a “Press here to Login” hyperlink are constructed with an HREF that includes “place=login”. When the server computer receives this request, it sets “Login.jsp” as the Target Place and does a dynamic include of “Header_Content_Footer.jsp.” Like all other site templates, at some point (most likely in the ‘Content’ part), it resolves the value of Target Place and does a dynamic include of its result (in this case, “Login.jsp”).

The previous example didn't cause any “business logic” to be executed. However, when the customer receives the resulting page (after clicking “Press here to Login”), fills in the UserName and Password form, and clicks “OK”, we have some processing to do. Suppose we have a class, LoginUser.java, which knows how to take a user-name and password and “log them in.” We would set up a Class Place, something like this:

<place id=“DoLogin” content=“LoginUser.java” type=“class”/>

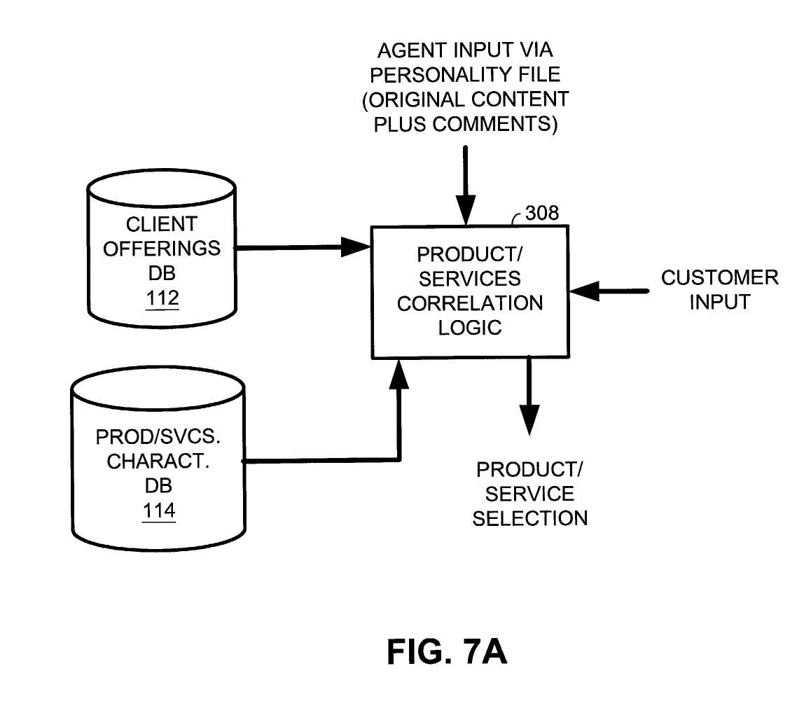

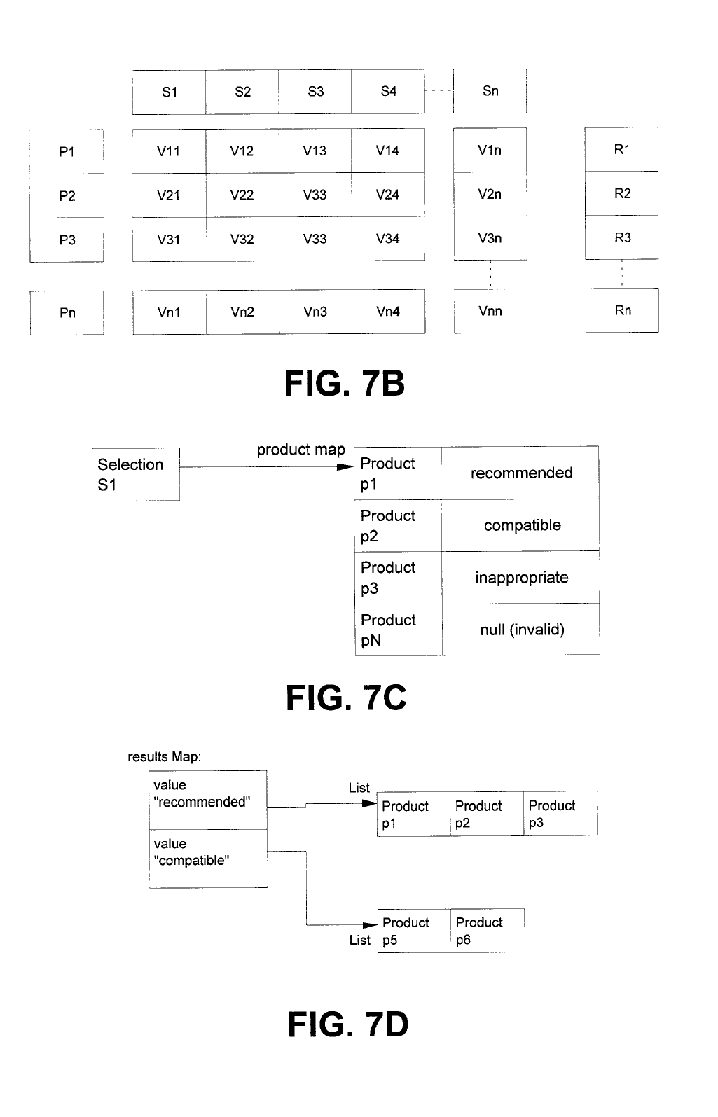

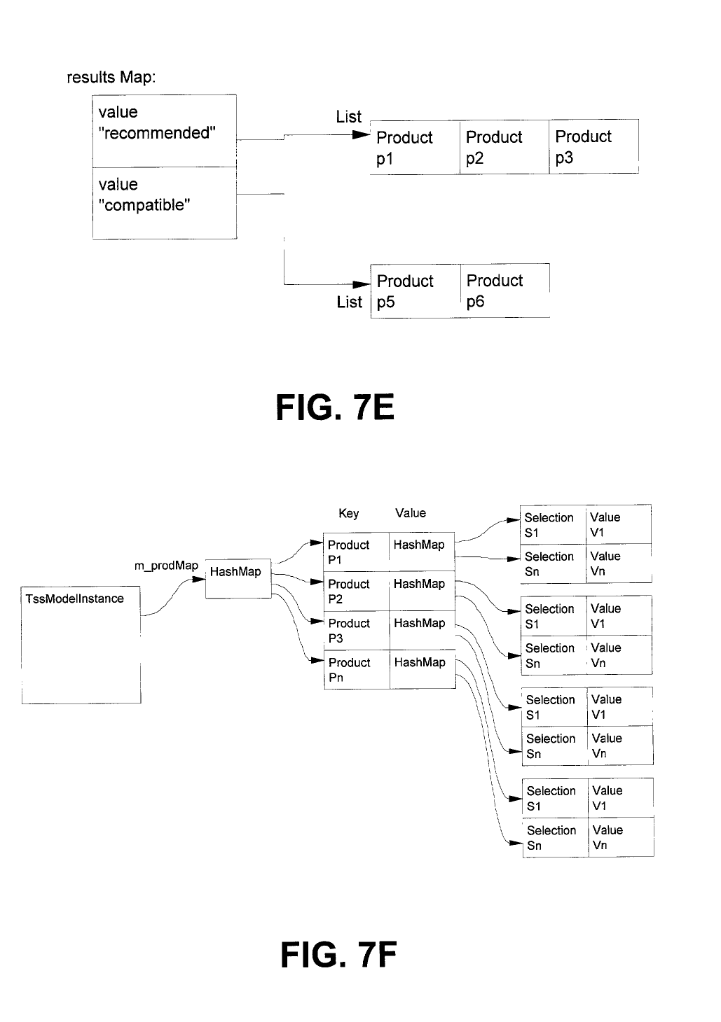

When the “Login.jsp” page generated the URL for the “OK” form button, it made sure it included (something like) “place=DoLogin.” When the customer clicks “OK”, the server computer decodes the place (DoLogin), sees that it's a Class Place, creates an instance of “LoginUser.class” and invokes its doIt( ) method, passing it the name and password arguments from the form. The business logic may include the product/services correlation logic 308 (that will be further described with reference to FIGS. 7A-7F.

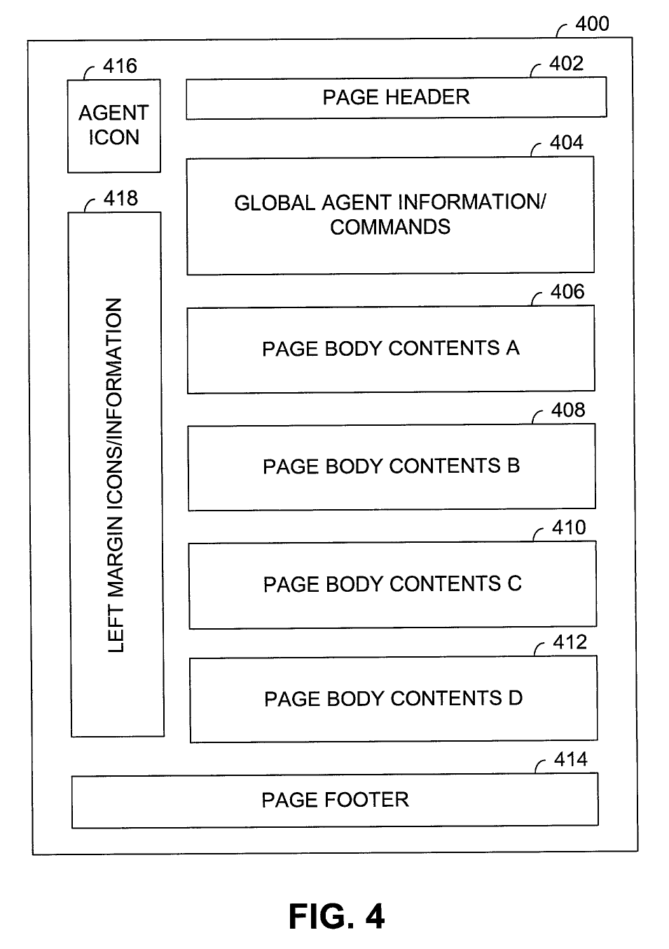

FIG. 4 is a block diagram generally illustrating one embodiment of a site template 400 constructed according to the present invention. The site template 400 includes a plurality of places that are filled with content based upon a PDF and delivered to a customer. The particular site template 400 includes a page header 402, global agent information/commands block 404, page body content place A 406, page body content place B 408, page body content place C 410 and page body content place D 412. The site template 400 also includes page footer 414, an agent icon place 416 and a left margin icons/information place 418. Each of these places in the template will be filled according to the contents of a PDF that accesses the site template 400.

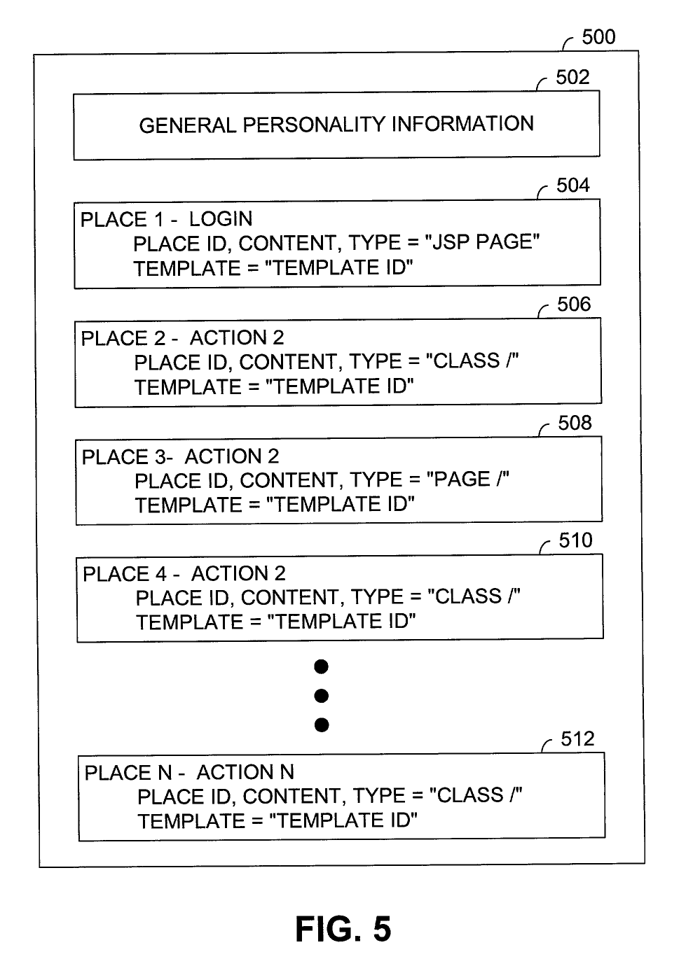

FIG. 5 is a block diagram generally illustrating one embodiment of a personality file (PDF) 500 constructed according to the present invention. As is shown, the PDF 500 includes general personality information 500 and a plurality of place information blocks 504-512. Each of these place information blocks 504-512 defines operations to be performed when a customer accesses the corresponding place ID. When the place ID is accessed, operations defined within the corresponding place information block are performed.

FIG. 6 is a block diagram illustrating components of the system of the present invention involved in operating upon a system state according to the present invention. Shown are a CCMS 604, a customer computer 602, an agent computer 606 and a state database 312. The Session State (SS) for a particular customer visit to the CCMS is represented in a collection of StateComponent (SC) objects, e.g., SC1, SC2, . . . , SCN. Each state component is registered with the SessionStateManager (SSM) under a unique name 307 (shown in FIG. 3). The state component name is used to retrieve the object.

The SS is managed independently of the application logic. The application logic can access and manipulate it, but the mechanisms used to provide its persistence are invisible to the application. This allows the state to be managed in the most effective way possible (e.g. SS can be encoded in a Cookie, in URLs, or in a shared file system.) as a function of the server computer configuration, the size of the SS, and the facilities provided by a specific browser (e.g. cookies disabled.)

StateComponents (those not used by the platform internals) are always represented in the XML as component elements, e.g.:

<component id=“shoppingcart” class=“ShoppingCart.java”/>

Application logic deals with “shoppingcart”, providing a level of indirection where the component becomes a factory for, in this case, a shopping cart.

In one operation according to the present invention an agent has established a personality file PDF that is accessed by a customer. Upon an initial login, via a URL supplied by the agent to the customer, the customer logs into the CCMS 604 and the particular PDF. This initial operation establishes at least one state component, SC1. Upon a first response to the customer computer 602, the CCMS 604 provides the state components that were established in the initial access. Then, when the customer acts again via the customer computer 602, the customer computer sends all (or a subset) of the state components to the CCMS 604 along with another URL or place ID corresponding to the customer's action. During subsequent exchanges between the CCMS 604 and the customer computer 602, state components are passed there between so that all required state components are maintained on the customer computer 602.

By having the customer maintain the state components, the servicing CCMS is not required to retrieve the state components from a storage device that is shared by all CCMSs. Further, such operations allow for ease in expansion in the number of CCMSs that can service operations.

In another operation according to the present invention, the customer desires to save the state for later access by his agent or by himself from a different computer. In such operation, the customer executes a save command, at which point the CCMS 604 saves a full copy of the state components to the state database 312. The agent using agent computer 606 may then login to the CCMS 604 and retrieve the customer's session status. In the session, the customer may have left questions for the agent to answer. Further, the agent may determine which part of the selection process that the customer reached and at what point the customer could go no farther. By retrieving the state, and interacting with the CCMS 604, the agent may answer the customer's questions and “assist” the customer in completing the selection process by entering data for the customer, answering questions for the customer, and generally serving as the customer's agent within the selection process.

When a customer desires to interface with the CCMS 604 from two or more different computers, the customer directs the CCMS 604 to save the system state. The CCMS 604 saves the system state in the state database 312. Then, when the customer accesses the CCMS 604 from a different customer computer, he or she simply recalls the state and continues with the selection process.

In each of these state maintenance and state saving operations, the location at which the customer currently resides, the location the customer was when he saved the state, or the location the customer was at which he quit working are also saved. However, login information is not saved with the other state components. With the state saving and restoring operations, a customer may maintain multiple selection sessions. When the customer restores a session, all current session information is overwritten. Thus, the CCMS 604 may be configured to prompt the customer to perform a state save operation prior to the state restore operation.

In a collaboration operation, when a customer saves a state, the CCMS 604 may initiate an email message, a call, a page, or other communication to the agent, notifying the agent that the customer needs assistance. Further, any modifications made by the agent may be highlighted or otherwise noted so that the customer may determine what changes the agent in the process made.

Difficulties exist with this state management technique when a cache server computer is employed, such as the cache server computer 214 shown in FIGS. 2 and 3. Such is the case because requests may be sent from the customer computer to the CCMS 604 and content may be sent from the CCMS 604 to a customer computer 602, either of which include incomplete state information. Thus, according to the present invention, caching reverse proxy (CRP) operations are supported by including necessary state components. By including these state components, the cache server computer 214 may effectively identify and correlate cached web pages with incoming requests.

Since caching is reliably effective only on requests with URLs that don't contain parameter lists, standard parameters (e.g. place, personality) are included in the URL/URI. On cache misses, the CCMS 604 has to work harder to extract what would have been parameters, but the benefit of allowing cache hits far outweighs this cost.

This solves the parameter problem, but a larger one remains—making sure the cached page's content actually matches the current state of the application. In other words, if the customer is now looking at telecom services for zip code 78759 (by going to Place ShowTCServices), but the cached page reflects the services for 46060, we don't want the cached copy to be returned. This is where the magic happens.

This problem is solved by first identifying which state components the target Place (e.g. ShowTCServices) uses to produce its viewable page. When generating a URL for the target Place, encoded in the URI is the externalized representation of all of (and only) those components—in this case the Zip Code Component (any other state components are externalized elsewhere in the page—most likely a cookie.) This means that the CRP will find a cache hit when, and-only-when the customer requests the same place, from the same personality, with the same state (in this case above, the same zip code.)

Of course, all of this depends on the ability to determine the state components that a target place is dependent upon. And fortunately, as described earlier, each Place describes the set of state components that it uses.

Here's an example for ShowTCServices:

<place id=“ShowTCServices” requires=“Zip Code”/>

<component id=“Zip Code” class=“zipc” factory=“GetZC.jsp”>

The “requires” attribute tells the StateStateManager that when it builds a URL for Place ShowTCServices, it should encode the content of the Zip Code component in the URI.

Since Session State is managed in a very dynamic and flexible way (URL rewriting, cookies, shared file system, URI encoding for CRPs), it's important to note some implications.

First, JSP pages cannot generate URLs directly, they must ask the SSM to do it. Assuming that earlier logic in the JSP page has resolved the reference wwr to refer to its JSPRequest object, then the following JSP code would correctly generate the URL:

<a href=‘<%wwr.genURLForHref(“Login”); %>’>Click To Login </a>

The Place name (in this case “Login”) is sufficient for deriving all the needed information for generating the URL.

Second, since the SSM may be encoding SS in URLs and/or cookies, the entire SS must be known before any URLs are generated (actually, even before Headers themselves are being generated since this is where cookies live.) For this reason, JSP pages cannot include logic that actually changes StateComponents. All SS changes must be made either via the ‘requires component=“component-name”’ facility or Class Places.

FIG. 7A is a logic diagram illustrating components of the system of the present invention involved in the selection of products and services. As is shown, the product/services correlation logic (PSCL) 308 receives customer input, agent input that may include both input from the personality file and subsequent input/comments, relevant client offerings information from the C/O DB 112 and relevant product/services characteristics from the PSC DB 114. As an output, the product/services correlation logic provides a product/service selection. This may include a single product/service or a multiple product/service, depending upon the requirements of the particular operation.

The PSCL provides a way to identify a set of ‘technologies’ and the perceived value of those technologies based on the characteristics of those technologies. Customer's responses to interactive input determine the current value of any specific technology.

A needs model is constructed in an XML file. The file defines a set of available technologies and the attributes of these technologies. (Actually, they are defined as ‘products’ in the file, but the system doesn't really care that what's being defined are technologies.) At the end of this document is a sample input model.

The needs model also defines a set of selections. A selection represents some input for which a customer would be prompted. For example, ‘how many customers will use your internet connection?’ or ‘what is your area code & prefix number?’.

Every customer selection must boil down to a selection object that is defined in the model. For every such selection, a set of conditions is identified. Conditions are objects that are evaluated at runtime. The implementation of a Condition is provided by a Java class that implements the IConditionHandler interface.

There are two types of condition:

A “must satisfy condition”

A “when condition”

The “must satisfy condition” indicates that each ‘technology’ in the system must satisfy the condition when evaluated. If such a condition fails for a ‘technology’, then it will be identified as ‘invalid’, and no other conditions are evaluated for that selection.

The “when condition” works like a switch statement in languages such as Java. The condition is evaluated and if it succeeds then a ‘technology’ is assigned a perceived value and the next ‘technology’ is evaluated. If the condition fails, the same technology is evaluated on the next available condition for the current selection.

For example, the following fragment of XML should make it easier to understand the previous discussion:

| | |
|---|---|
| <selection id=“location” | type=“string”> |

| <mustsatisfy condition=“availableInLocation”/> | |
|---|---|
| <when condition=“true” | set=“recommended”/> |

</selection>

| | |
|---|---|
| <selection id=“userCount” | type=“intRange”> |
| <when condition=“sizeMatches” | set=“recommended”/> |

| | |
|---|---|
| <when condition=“sizeNear” | set=“compatible”/> |
| <otherwise | set=“inappropriate”/> |

</selection>

The above indicates that when a ‘location’ selection is made the ‘availableInLocation’ condition must be satisfied for any technology to be considered valid. Then, if that condition is satisfied, then the subsequent ‘when’ statement indicates the technology is recommended (since the condition ‘true’ is always true).

For the ‘userCount’ selection, the technology will be recommended if the ‘sizeMatches’ condition is true. If it is not true, then the subsequent condition ‘sizeNear’ is evaluated and if true then the technology is marked as only ‘compatible’.

Describing this process at a higher level of abstraction, the PSCL 308 determines the value of some specific technology/product Pn based on a set of selections that relate to it.

FIG. 7B illustrates the concepts behind the technology selection component of the PSCL 308. The set of available selections are represented across the top of FIG. 7B. For example, ‘S1’ might be the ‘location’ selection of the previous example. The set of products/technologies are represented down the left side of the diagram (P1 to Pn).

When a selection such as ‘S1’ is made, the conditions (not pictured) for that selection are evaluated and a value is assigned (V11 to Vn1) based on these conditions that is related to both that selection and each product/technology. (P1-Pn). Each selection (S1 to Sn) results in a similar vector of values that have been computed relative to the selection.

After every selection is made and values computed, a ‘results’ vector (R1 to Rn) is subsequently computed based on the aggregated results of the values assigned to any given product/technology. For example, the values (V11 to V1n) are evaluated to determine an overall result=R1 for product P1. R1 is said to be the overall current value of the product P1.

To drive the technology selection, an application gets access to TssModelInstance object. Typically, this is done by having the “CompTechSelect” class session state component:

IStateComponent comp=wwr.getComponent(“TechSelect”);

CompTechSelect techSelect=(CompTechSelect)comp;

With the component in hand, you can access the TssModelInstance for the current session:

TssModelInstance mi=techSelect.getModelInstance( );

When a customer selection is made, the presentation layer of an application using the model gets access to an instance of a TssModel object. (The TssModel is the output of parsing the input XML model file.) The application then invokes the select method of the model. For example:

model.select(“location”, “512258”);//area-code & prefix

The first argument to the select method is the ID of a selection object (see example definition in the XML above.) The second argument to the method is the customer input value.

The model reacts to a selection by iterating over all input products/technologies. For each, the conditions of the specific selection are evaluated. The result is a set of perceived values for the selection and is in FIG. 7C.

Once a selection has been evaluated, the selection is applied to each product in the selection's product map. Effectively, what this amounts to is a set of perceived values for a product/technology, by selection. This is shown in FIG. 7D.

Once a selection has been made, an application can request the perceived value results that have been determined by the model. To do this, a call is made on the model to getResultsByProduct( ) or getResultsByValue( ). For example:

Map results=model.getResultsByValue( );

What happens when this is called is getProductValue( ) is called for each product. This call aggregates the product's perceived values for all selections that have affected the value of the product. To do this, a comparator object is used. A comparator is an object that implements the IValueComparator interface, which supports the following method:

public Object compare(Collection values);

The values assigned by selection conditions are collected and passed to the comparator. It in turn decides how the collected set of values is to be interpreted. It returns a single value based on the value for all selections. The getResultsByValue method on the model returns a Map object. Consult javadoc for details. But, for the example above, the results are illustrated in FIG. 7E.

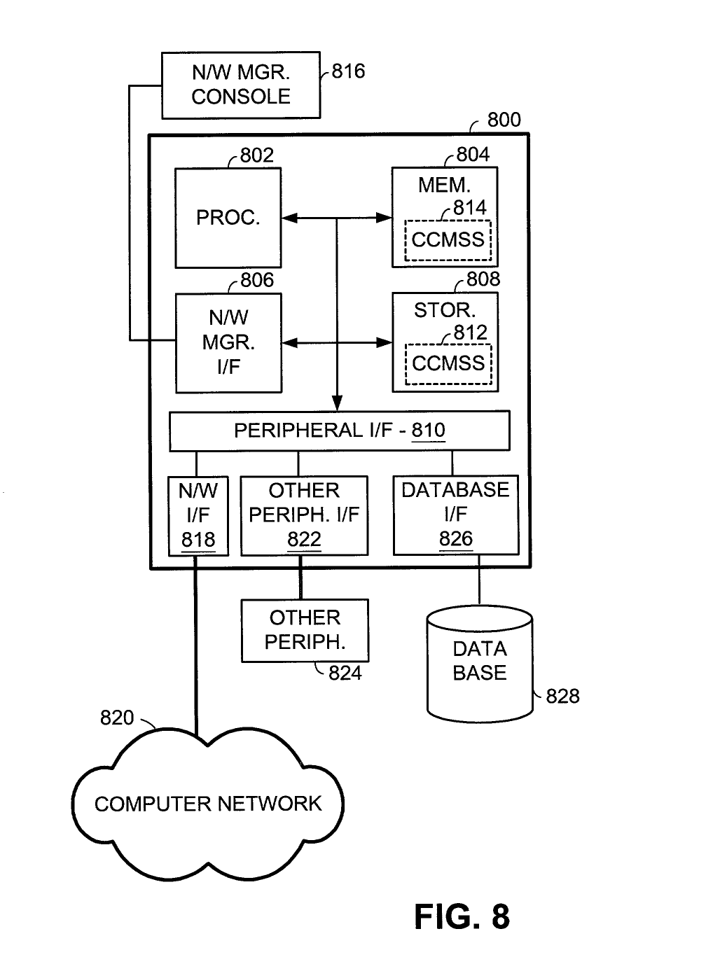

FIG. 8 is a block diagram illustrating a content creation and management server computer (CCMS) 800 constructed according to the present invention. The CCMS 800 may be a general-purpose computer that has been programmed and/or otherwise modified to perform the particular operations described herein. However, the CCMS 800 may be specially constructed to perform the operations described herein.

The CCMS 800 includes a processor 802, memory 804, a network manager interface 806, storage 808 and a peripheral interface 810, all of which couple via a processor bus. The processor 802 may be a microprocessor or another type of processor that executes software instructions to accomplish programmed functions. The memory 804 may include DRAM, SRAM, ROM, PROM, EPROM, EEPROM or another type of memory in which digital information may be stored. The storage 808 may be magnetic disk storage, magnetic tape storage, optical storage, or any other type of device, which is capable of storing digital instructions and data.

The network manager interface 806 couples to a network manager console 816, which allows a manager to interface with the CCMS 800. The network manager console 816 may be a keypad/mouse/display or may be a more complex device, such as a personal computer, which allows the manager to interface with the CCMS 800.

The peripheral interface 810 couples to a network interface 818, a peripheral interface 822 and a database interface 826. The network interface 818 couples the CCMS 800 to a network 820 that may be the Internet (WWW) or another network. The other peripheral interface 822 couples the CCMS 800 to other peripherals 824. The database interface 826 couples the CCMS 800 to a database 828 (when included), which stores content and data relating to the functions of to the present invention. Content Creation and Management Server Software (CCMSS) 812 is loaded into the storage 808 of the CCMS 800. Upon its execution, a portion of the CCMSS 812 is downloaded into memory 804 (as CCMSS 814). The processor 802 then executes the PSS 814 instructions to perform the operations described herein. The programming and operation of digital computers is generally known to perform such steps. Thus, only the functions performed by the CCMS 800 will be described and not the manner in which the processor 802 and the other components of the CCMS 800 function to perform these operations.

The CCMSS 812 illustrated with reference to FIG. 8 may include software instructions to instantiate the grapevine protocol that will be discussed with reference to FIGS. 9 through 13. The grapevine protocol operates to store customer and agent session states on a plurality of CCMSs. Thus, software instructions that instantiate the grapevine protocol will reside on each CCMS that may service the customers and agents according to the present invention.

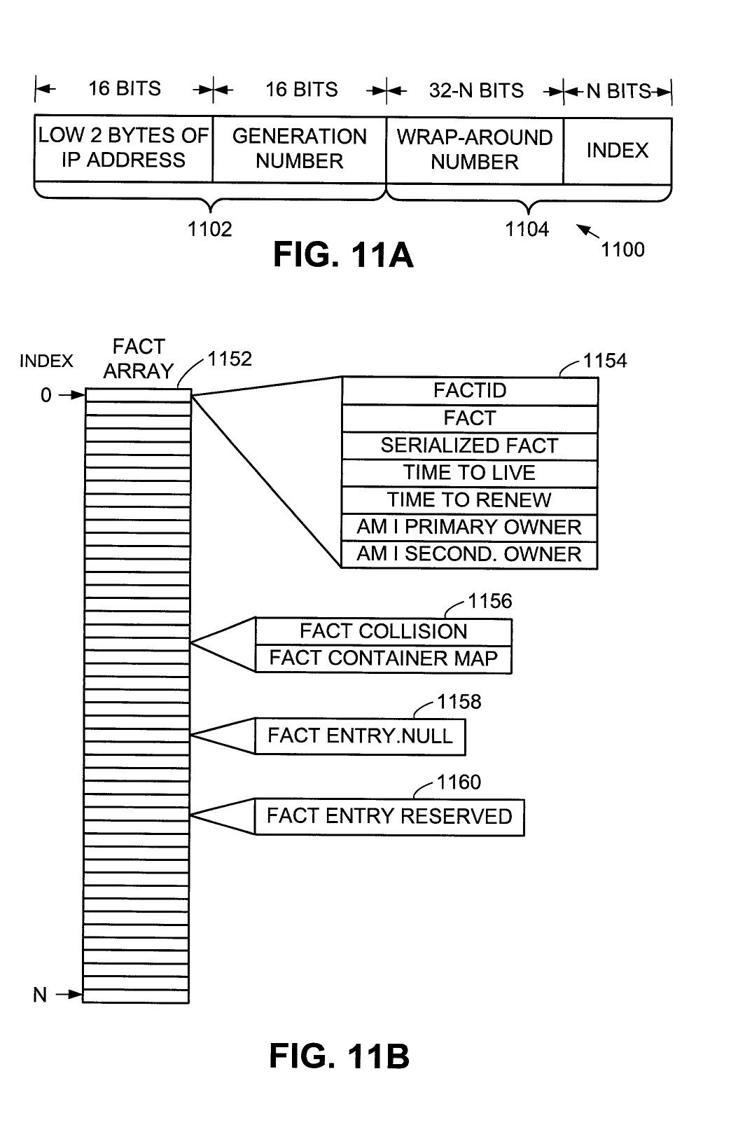

FIG. 9 is a system diagram illustrating a system constructed according to the present invention in which session states are maintained on all server computers (CCMSs) forming a server computer farm. The server computer farm includes CCMSs 902A, 902B, 902C, 902D, 902E and 902F that are coupled via computer networks 900. Each of the CCMSs 902A-902F runs an instantiation of the grapevine protocol, 904A-904F, respectively. The structure and operations of the grapevine protocol will be discussed in more detail with reference to FIGS. 11-13. Generally speaking, the instantiations of the grapevine protocol, 904A-904F, operate so that the CCMSs 902A-902F each store copies of substantially all session states created for customers 906A, 906B and 906C as well as for agents 908A and 908B.

Generally speaking, one of the CCMSs, e.g., 904A, will service a request from a customer, e.g., 906C. The customer's 906C visit is the first to any of the CCMSs 902A-902F. Thus, the CCMS 904A creates a session state (also referred to more generally as a Fact) and responds to the customer 906C. The CCMS 904A then broadcasts the session state to each other of the CCMSs 904B-904F. The other CCMSs 902B-902F receive the broadcast and make copies of the session states in their own memory, hard drive, or other storage device.

Subsequently, the customer 906C sends a query to CCMS 902E, which did not service the prior query. Upon receipt of the query, the CCMS 902E, having a copy of the customer's session state in its memory, retrieves the session state and services the customer query based upon the contents of the session state. Subsequently, the CCMS 902E then broadcasts the modifications it made to the session state to each other of the CCMSs 902A-902D and 902F. Upon their receipt of these modifications, the CCMSs 902A-902D and 902F then update their copies of the customer session state. These operations continue for the customer's session state until the session state is deleted for non-use.

In an alternate operation according to the present invention session states are not modified. Instead, whenever a session state is accessed, a new session state is created and the old session state is deleted. In this embodiment, therefore, modification operations are always performed by the combination of a delete operation and a creation operation.

The grapevine protocol, e.g., 904A on CCMS 902A, is a set of operations accessible by the master logic 304 of FIG. 3, for example. However, the grapevine protocol 904A may be used to manage session state in any type of system in which a plurality of server computers interact to service a plurality of users and the maintenance of user session state is required. Thus, the grapevine protocol 904A may replace systems in which a user session state is stored in a cookie, as part of URLs in web pages, on a dedicated server computer, in a database, etc.

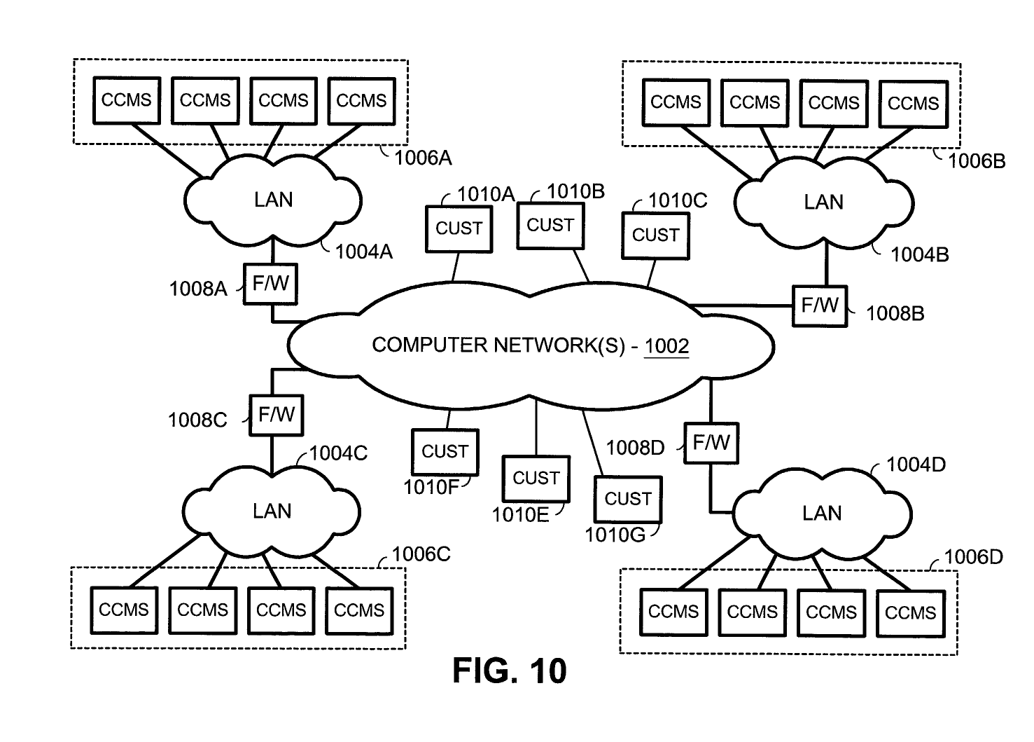

FIG. 10 is a system diagram illustrating an alternate construction of a system according to the present invention in which session states are maintained on all server computers (CCMSs) forming groups of server computer farms. As is shown a plurality of server computer farms 1006A, 1006B, 1006C and 1006D each includes a plurality of CCMSs. Each of these CCMSs performs operations that have been previously described herein. The groups of CCMSs forming the server computer farms 1006A, 1106B, 1006C and 1006D are intercoupled by LANs 1004A, 1004B, 1004C and 1004D, respectively. These LANs 1004A-1004D provide relatively high-speed interconnection among those CCMSs coupled by the LANs. Thus, broadcasting session states among the CCMSs coupled by the LANs is easily supported by the relatively high speed LANs.

Each of the LANs 1004A-1004D couples to other computer networks 1002, e.g., the Internet, via firewalls 1008A-1008D, respectively. Customers 1010A-1010G couple to the computer networks 1002 and may couple to any of the CCMSs via the computer networks 1002 and respective firewalls and LANs, e.g., firewall 1008A and LAN 1004.

In one operation according to the present invention, a single server computer farm services a single customer. For example, customer 1010G is serviced by server computer farm 1006A. Thus, any CCMS of the server computer farm 1006A may service queries from the customer 1010G, but, none of the other server computer farms 1006B-1006D will service the queries. Thus, the customer's session state must only be maintained on the CCMSs of server computer farm 1006A. Because the CCMSs of the server computer farm are coupled via the high speed LAN 1004A, such maintenance may be performed without overloading network resources.

However, if a customer, e.g., customer 1010F, may access any CCMS of any server computer farm 1006A-1006D, the customer session state must be stored on substantially all of the CCMSs of all of the server computer farms 1006A-1006D. Grapevine operation in this embodiment would require significantly more resources to accomplish. Thus, it is advantageous to direct customer traffic to particular server computer farms.

FIG. 11A is a block diagram illustrating the structure of a Fact ID 1100 that serves to identify a session state (or component thereof) managed by the systems of FIGS. 9 and 10. Each session state may be referred to as a Fact. However, each session state may be stored as a plurality of Facts. Thus, the operation of the grapevine protocol is discussed hereinafter primarily with reference to the term Fact. While, in many cases, a single Fact represents a complete session state, in other cases, multiple Facts are employed to store a complete session state.

The remainder of the discussion of the grapevine protocol uses a particular set of terminology. Here are some of the terms and how they relate to the grapevine protocol:

Fact—a session state or a portion of a session state. In general, a Fact is a piece of information that participants share. Facts are valid for only some amount of time.

FactID—a globally unique identifier for a Fact.

Publisher—a server computer (CCMS) that publishes facts.

Subscriber—a server computer (CCMS) that listens for grapevine activity and keeps track of Facts derived from that activity.

Participants—a publisher and a subscriber, CCMSs that share facts.

The grapevine protocol, in one embodiment, is created using an object-oriented methodology. To instantiate the grapevine protocol using the object-oriented methodology, a programmer may perform the following steps:

1. Create a configuration properties file with an arbitrary name (for now, let's assume it is called “foo.properties” and place it in the CLASSPATH of all server computers that are to share facts using the grapevine protocol. The file contains configuration information that will be described later. The file should be the first file with that name in the CLASSPATH and be writeable by the process that will be running the grapevine protocol;

2. Instantiate an IFacts object using: IFacts facts=Facts.forFile (“foo.properties”); and

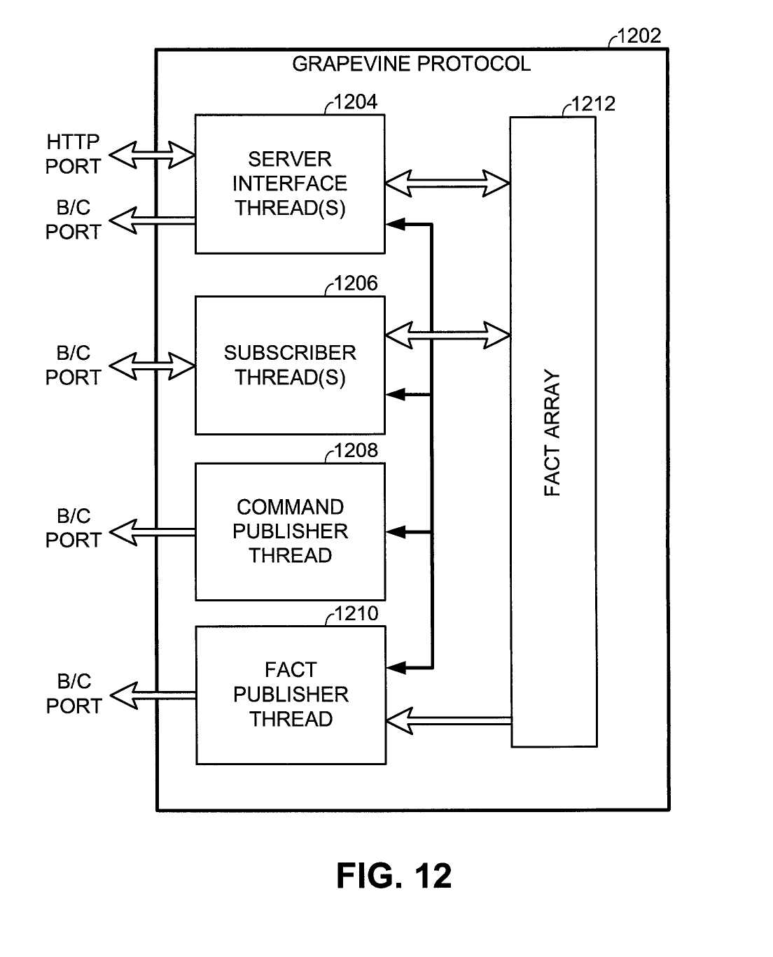

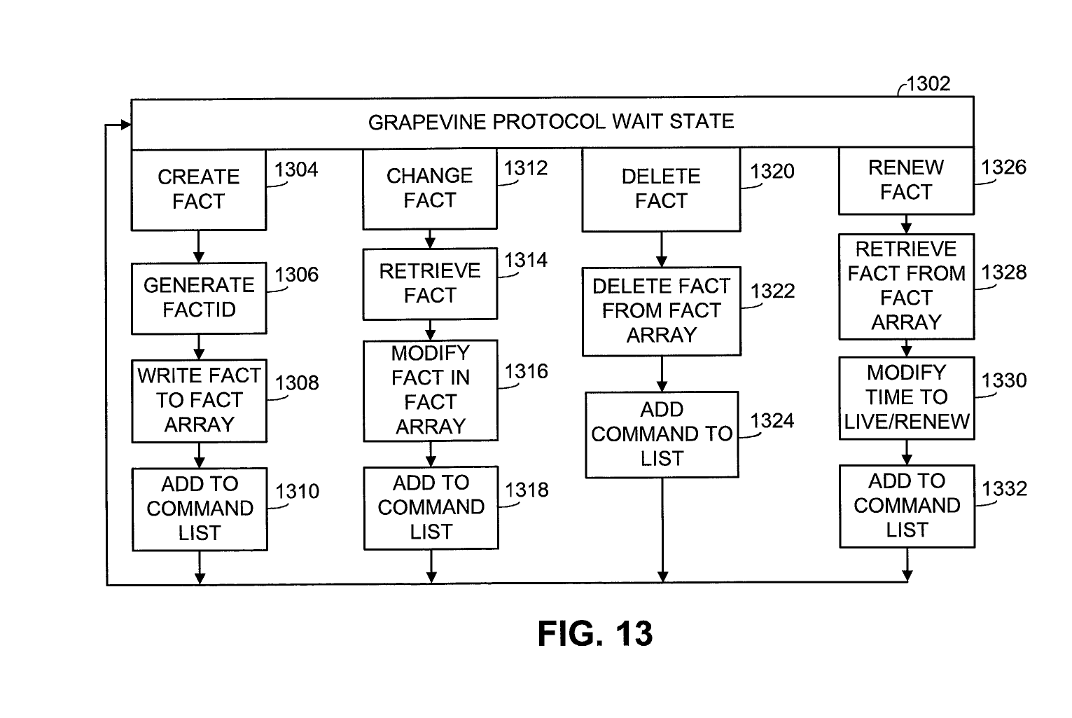

3. Use the IFacts object to manage arbitrary facts. Commands that may act upon the IFacts object include the get/add/delete/change/renew commands. These commands will be discussed in more detail with reference to FIGS. 12 and 13. The only restriction on the type of Fact that may be managed is that the Fact must be Serializable.

A typical configuration file looks like this:

class=com.whisperwire.grapevine.BroadcastFacts

entriesPerCycle=5

fyiPublisherCycle=100

fyiPublisherPriority=4

genNumConfigFile=genNum.properties

maxBroadcastsPerTimeUnit=5

maxFacts=500

millisPerTimeUnit—1000

pipe.addresses=224.0.0.1:4000

pipe.class=com.whisperwire.grapevine.Pipe

publisherCycle=1000

publisherPriority=5

queryTimeout1stAttempt=500

queryTimeout2ndAttempt=1000

secondsToLive=2

secondsToRenew=1

silenceTimeToFeelLonely=200

span=1

subscriberPriority=4

subscriberThreads=2

This file is updated every time the process that is running the grapevine protocol runs, comments are removed at this point.

This is what these properties are:

class—the class used to instantiate the IFacts object. The com.whisperwire.grapevine.BroadcastFacts class includes algorithms used for broadcasting facts. Other classes may be added in the future to: (1) relax the restriction that session state be maintained in memory; (2) log changes to facts; (3) and to make other changes.

entriesPerCycle—the number of entries the garbage collector removes every time it runs.

fyiPublisherCycle—the number of milliseconds the publisher thread sleeps in between sending instances of CommandsFyi.

fyiPublisherPriority—the priority (in Java terms) of the thread that publishes instances of CommandFyi.

genNumConfigFile—the name of a properties file with a single property called ‘generationnumber’ which is explained below.

generationNumber—the only property modified by the grapevine protocol is the generationNumber. All other properties are provided by an administrator. The initial generation number must also be provided as a positive short number. It is used to generate FactIDs that don't collide with FactIDs generated in a previous run. This property is kept in a separate file to allow all participants to use the exact same property file for all other configuration parameters.

maxBroadcastsPerTimeUnit—The maximum number of broadcasts allowed in the network per time unit for this instantiation of the grapevine protocol.

maxFacts—the size of the facts array. If more than this number of facts exists in the grapevine at any given time, then entries added when the grapevine is in this state are represented as FactCollisions, which is less efficient. The array of facts is similar to a hash table.

millisPerTimeUnit—the number of milliseconds in a time unit. This parameter only affects the interpretation of the maxBroadcastsPerTimeUnit parameter, and also how often participants react to changes in the number of broadcasts seen in the network.

pipe.addresses—one or more IP addresses or host names and ports separated by spaces.

Each of these addresses is used as a destination address when broadcasting facts. Usually, this is a single multicast address (such as 224.0.0.1), but it can be the names or IP addresses of hosts.

In this case, instead of broadcasting, facts are sent to each of those addresses. It is valid to list the name or IP address of the current host. It will be ignored. The proper format for this property is: pipe.addresses=addr1:port1 addr2:port2 . . . Where addrx is either an IP address or a host name and portx is a port number that is associated with that address. The common form of this is: pipe.addresses=224.0.0.1:4000 to broadcast facts on port 4000. Another form is: pipe.addresses=host1:4000 host2:4000 host3:4000. this would go in a configuration file to connect 3 hosts without broadcasting, another potential variation is: pipe.addresses=localhost:4000 localhost:4001 to start 2 processes in the same machine and get them connected. Note that in this case, the second process must have a configuration file with: pipe.addresses=localhost:4001 localhost:4000 since the port on the first local host address is the one chosen to receive packets.

pipe.class—the name of the class that implements the com.whisperwire.grapevine.Pipe.

Other protocols may be supported in the future to: (1) support different topologies for fact dissemination; (2) use something other than UDP as the underlying protocol; or (3) make other changes.

publisherCycle—the number of milliseconds the publisher thread sleeps before attempting to resend a Command.

publisherPriority—the priority (in Java terms) of the publisher threads.

queryTimeout1stAttempt—the number of milliseconds to wait for a reply when the IFacts.get method is invoked, the FactID is not found locally and we make the first attempt to retrieve the FactContainer from the grapevine by requesting it from its owners.

queryTimeout2ndAttempt—the number of milliseconds to wait for a reply on the second attempt to retrieve a fact from the grapevine. The scenario is as follows: (1) The IFacts.get method is invoked; (2) the FactID is not found locally; (3) a first attempt to retrieve the FactContainer from the grapevine is made by requesting it from its owners; (4) the first attempt fails; (5) a second attempt to retrieve the FactContainer from the grapevine is made by requesting it from any participant that has it.

secondsToLive—the default number of seconds that a fact lives.

secondsToRenew—the default number of seconds that need to transpire before a fact can be renewed.

silenceTimeToFeelLonely—the number of milliseconds that need to elapse without a participant seeing broadcasts from others before it concludes it is alone. Once a participant feels lonely, it starts to broadcast only heartbeats. It is recommended this number be greater than the smaller of publisherCycle and fyiPublisherCycle.

span—when allocating a new FactID, it is important to pick one with an index that another participant does not pick concurrently. This minimizes the number of collisions. The span is a small number so that instead of participants always picking the smallest index known to be available at the time, a random integer number n between 0 and span-1 is generated whenever a new index is needed, then the nth known smallest index is used instead.

subscriberPriority—the priority (in Java terms) of the subscriber threads.

subscriberThreads—the number of threads used as subscribers.

Referring again to FIG. 1A, FIG. 1A shows a FactID 1100. Further, FIG. 1B illustrates a FactArray 1152 that serve to index and store Facts corresponding to the FactIDs 1100. FactIDs 1100 are kept on the browser of a customer computer via URL-rewriting or cookies. The FactID 1100 is chosen so that, with it, the state (fact) can quickly be retrieved from main memory. Because the CCMS needs to be sure that the state of the session it has is current, the FactID for the corresponding user needs to change whenever the user's state changes. To facilitate memory reclamation, this FactID contains an ever-increasing number. So, if you think of all known session states as an array indexed by this number, then the head of the array is continuously being garbage collected (as indicated by the timeToLive of any given fact).

The physical FactArray is of a fixed (configurable) size and the FactID 1100 transformed by a function modulo the size of the array is the index, so it wraps around. This means that session states expire based not on when they were used last, but on when they changed last. To make this palatable, the system has a system-wide configurable parameter called timeToRenew that is used as follows: If a fact is accessed and its timeToRenew has come, then it is treated as if it had changed (assigned a newer index) to breathe life into it.

In the described embodiment, each FactID 1100 has 64 bits and contains a publisherID 1102 and a FactIndex 1104. The publisherID 1102 identifies the originating publisher (CCMS) of the Fact and includes the 16 bits of its IP address 1102 and a generation number for the CCMS 1104, also 16 bits. This is used in case the machine needs to reboot, so that new identifiers assigned by it cannot conflict with old ones. During server computer boot, a file with the generation number is read, the number is incremented by 1 (as a short) and the file rewritten so it is ready for the next reboot.

The FactIndex 1104 maps into the array of facts. This is a combination of two numbers, the index into the array and the wraparound number. The wraparound number indicates how many times we have gone around the array (wrapped around) so that very old sessions are not confused with new ones. The FactIndex is a 32-bit number that is ever increasing for a specific machine (except when it wraps around to 1). Given the FactIndex, the array index is (FactIndex % array.length). The array length is configurable system-wide. The FactIndex wraps to one when, before incrementing, it is equal to the largest multiple of array.length representable with a (32 bit) number.

FIG. 11B illustrates a FactArray 1152 that serves to index facts based upon FactIndices. The FactArray 1152 has a length of N. The array of Facts is defined, in one embodiment as:

class FactArray {

private FactEntry[] m_facts;

// ...

FactContainer get(FactID FactID) { ... }
void add(FactContainer factContainer) { ... }
Object del(FactID FactID) throws GrapevineException { ... }

}

The physical array of facts for a given participant is in FactArray.m_facts, this is encapsulated in a class, to provide higher-level primitives to access the array. Each element of the FactArray 1152 is a FactEntry (usually, either a null entry 1158, a FactCollision 1156 or a FactContainer 1154. However each element of the FactArray 1152 may also be a FactEntry reserved 1160 for the short period of time, e.g., a few milliseconds, in which a corresponding location in the FactArray 1152 has been allocated for a FactContainer 1154 but not yet populated.

In one particular embodiment, FactEntry is the abstract superclass of FactContainer and FactCollision. There are methods to add and delete Facts, as well as to retrieve facts. The FactEntry is defined as follows:

abstract class FactEntry {
abstract FactContainer get(FactID id);
abstract int add(FactEntry[] array, int index, FactContainer c);
abstract int del(FactEntry[] array, int index, FactID id);
abstract int del(FactEntry[] array, int index, int timestamp);
}

In FactEntry there are two constants of type FactEntry defined:

NULL (FactEntry.Null 1158) is placed in all entries in the fact array that are currently unoccupied (in lieu of placing a null).

RESERVED (FactEntry.Reserved 1160) is placed in all entries in the FactArray 1152 for new FactContainers that have been generated (with their corresponding FactIDs) but have not yet been placed in the array, they are used to ensure that the corresponding FactIDs are not used by other threads to create other FactContainers.

Each subclass of FactEntry knows how to:

get a FactContainer from a given FactID,

add a new FactContainer to the array of Facts,

delete a FactContainer with a given FactID from the array of facts, and

delete all FactContainer that were supposed to die before a given timestamp from the array of facts.

The FactContainer 1154 is used to hold a fact and its corresponding administrative information. FactContainers 1154 are placed in the fact array so they can be found efficiently given its FactId.

A FactContainer is defined as:

```
  public class FactContainer extends FactEntry, implements Serializable {
  // the id of this fact
  private FactId m_id;
  // a reference to the Fact itself
  private Object m_fact;
  // one bit represents whether I am the primary owner,
  // another whether I am the secondary owner
```

private int m_flags;
// when should the fact die

```
  private int m_timeToLive;
  // when should the fact be renewed (if at all)
  private int m_timeToRenew;
  // a byte[] which, when streamed in, produces an
  // object which is the fact itself
  private byte[] m_serializedFact;
  public FactContainer get(FactId factId) { ... }
  public int add(FactEntry[] array, int idx, FactContainer f) { ... }
  // ...
}
```

A FactCollision object 1156 occurs when two or more server computers assign the same FactIndex. The algorithm is designed to reduce the probability of collisions, but they can happen. In that case, a FactCollision object 1156 contains a Map of FactIDs to FactContainers, when a participant detects a collision for the first time, it replaces m_facts[idx] with a reference to a Collision object with 2 elements (pointers to FactContainers 1154): the one originally stored in m_facts[idx] and the new one that collided. This logic is in FactContainer.add( ). When the FactContainer 1154 becomes empty or has only one element, it replaces itself with FactEntry.NULL or with the proper FactContainer in the array of facts. A FactCollision 1156 is instantiated as follows:

class FactCollision extends FactEntry {

private Map m_map;
public Fact get(FactId factId) { ... }
public int add(Fact fact, FactEntry[] facts) { ... }
// ...

}

FIG. 12 is a block diagram illustrating the architecture of one embodiment of the Grapevine Protocol 1202 constructed according to the present invention. The Grapevine Protocol 1202 includes a plurality of threads. As is generally known, a thread performs a certain set of operations/processes. The Grapevine protocol 1202 includes Server Interface Thread(s) 1204, Subscriber Thread(s) 1206, Command Publisher Thread(s) 1208 and a Fact Publisher Thread 1200.

The Server Interface Thread(s) 1204 couples to an HTTP port and to a Broadcast Port (B/C Port). The Server Interface Thread(s) 1204 couples to the Subscriber Thread(s) 1206 and to the Command Publisher Thread 1208 and operates upon the FactArray 1212. The Server Interface Thread(s) 1204 receives requests for Facts from other processes operating on a serviced CCMS, e.g., as shown in FIG. 3 and access the FactArray 1212, attempting to retrieve and return the Fact corresponding to a received FactID. If the Fact is present in the FactArray 1212, the Server Interface Thread(s) 1204 retrieves the Fact and returns it to the requesting process. The Server Interface Thread(s) 1204 also operates upon the FactArray 1212 according to any creation, deletion, or modification operations for the Fact. If the Fact is not present in the Fact Array 1212, the Server Interface Thread(s) 1204 broadcasts a GET command via the B/C port, requesting the Fact from other instances of the Grapevine Protocol, and waits for a copy of the Fact to be returned. These operations will be discussed in detail with reference to FIGS. 13, 14 and 16.

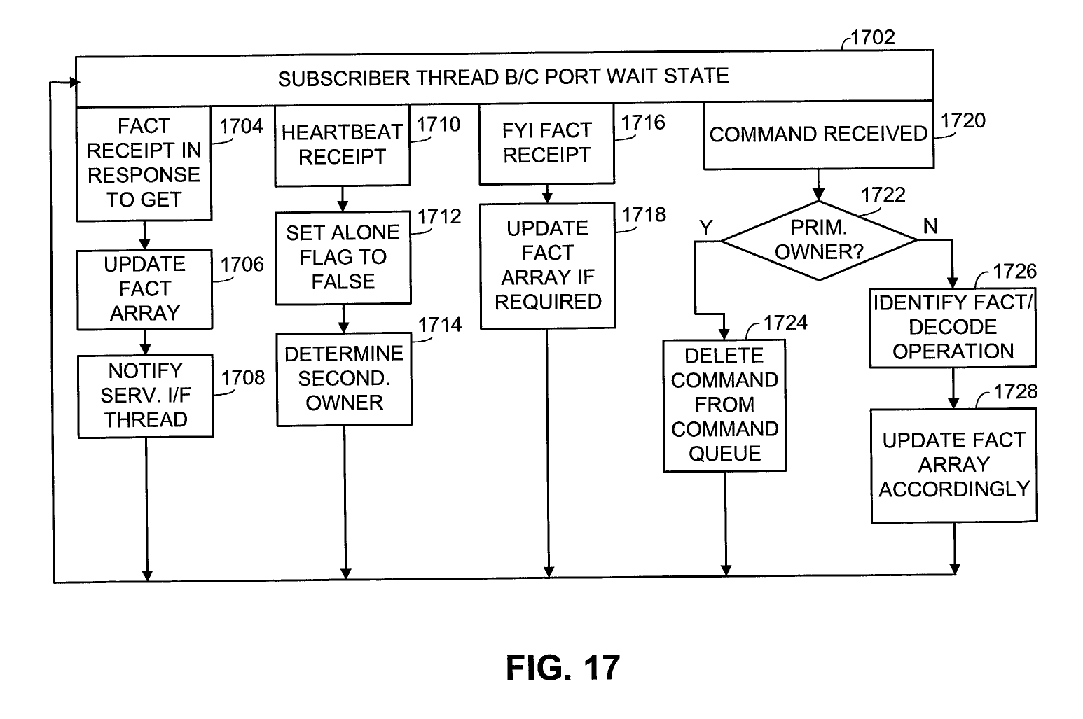

The Command Publisher Thread 1208 couples to the B/C port, to the SIT, and to the ST. The Command Publisher Thread 1208 maintains a command list that is populated with commands received from the SIT. Each of these commands represents an alteration made by the Server Interface Thread(s) 1204 to Fact(s) contained in the FactArray 1212. On a regular basis, the Command Publisher Thread 1208 publishes the commands that are contained in the command list to other instances of the Grapevine Protocol. The Command Publisher Thread 1208 also receives indications of commands received by the ST. If the Command Publisher Thread 1208 receives an indication from the Subscriber Thread(s) 1206 that another instance of the Grapevine Protocol has echoed the command, the Command Publisher Thread 1208 removes the command from the command list. This operation will be described in more detail with reference to FIG. 17. The Command Publisher Thread 1208 also receives indications from the Subscriber Thread(s) 1206 as to whether the Grapevine Protocol is alone and, if not, who are the primary and secondary owners of Facts managed by the plurality of instances of the Grapevine Protocol instantiated by the CCMSs.

The Subscriber Thread(s) 1206 couples to the Server Interface Thread(s) 1204 and to the Command Publisher Thread 1208 and to a B/C port. The Subscriber Thread(s) 1206 receives responses to GET commands published by the SIT, responses to heartbeats published by the CPT, responses to commands published by the CPT, and commands published by other instances of the Grapevine Protocol operation on other CCMSs. When the Subscriber Thread(s) 1206 receives a response to a GET command published by the SIT, the Subscriber Thread(s) 1206 updates the FactArray 1212 according with the Fact received. Then, the Subscriber Thread(s) 1206 wakes up the Server Interface Thread(s) 1204 that issued the GET command so that the Subscriber Thread(s) 1206 can access the Fact in the FactArray 1212.

When the Subscriber Thread(s) 1206 receives a response to a heartbeat published by the CPT, the Subscriber Thread(s) 1206 notifies the Command Publisher Thread 1208 that it is not alone and also notifies the Command Publisher Thread 1208 of the current secondary owner. The Command Publisher Thread 1208 will employ this secondary owner until a new secondary owner is identified. When the Subscriber Thread(s) 1206 receives a response to a command published by the CPT, typically from the secondary owner of the Fact that is affected, the Subscriber Thread(s) 1206 notifies the Command Publisher Thread 1208 of the response and the Command Publisher Thread 1208 removes the command from its command list.

When the Subscriber Thread(s) 1206 receives a command on the B/C port from another instance of the Grapevine Protocol, the Subscriber Thread(s) 1206 alters the FactArray 1212 accordingly. Further, if the Subscriber Thread(s) 1206 determines that the Grapevine Protocol 1202 is the primary or secondary owner of the Fact, it echoes the command to the source of the command. The Subscriber Thread(s) 1206 also responds to GET requests from other instances of the Grapevine Protocol. In responding to a GET request, the Subscriber Thread(s) 1206 accesses the FactArray 1212 and sends the corresponding Fact to the requesting instance of the Grapevine Protocol. In the described embodiment, when the Grapevine Protocol 1202 is the primary owner or secondary owner of a corresponding Fact, the Subscriber Thread(s) 1206 responds to a first broadcast of the GET request. The Subscriber Thread(s) 1206 responds to a second broadcast of the GET request, whether it is the primary of secondary owner, or not.

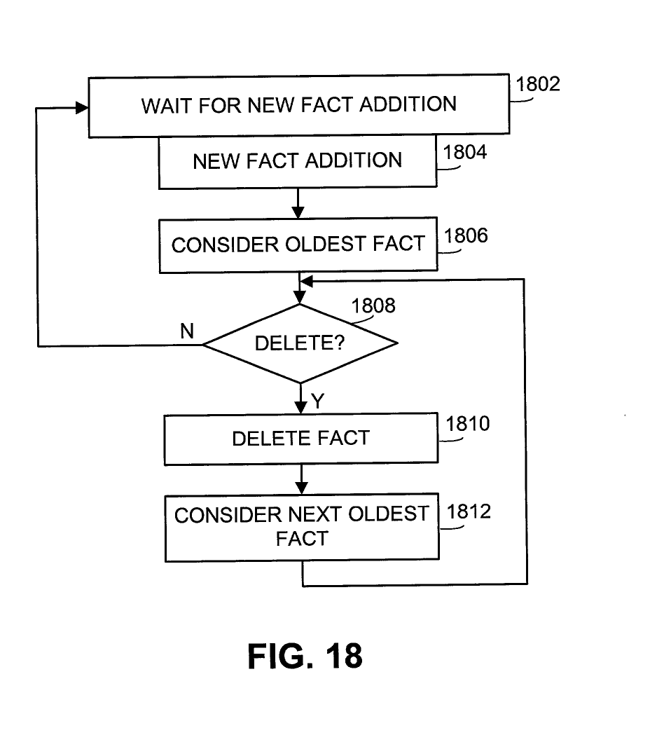

The Fact Publisher Thread 1210 uses available bandwidth to publish Facts contained in the FactArray 1212 to other instances of the Grapevine Protocol. The Fact Publisher Thread 1210 will publish facts as long as other instances of the Grapevine Protocol are instantiated. This operation works to ensure that all instances of the Grapevine Protocol have up to date copies of Facts in their respective FactArrays. The operations of the Fact Publisher Thread 1210 will be discussed in more detail with reference to FIG. 18.

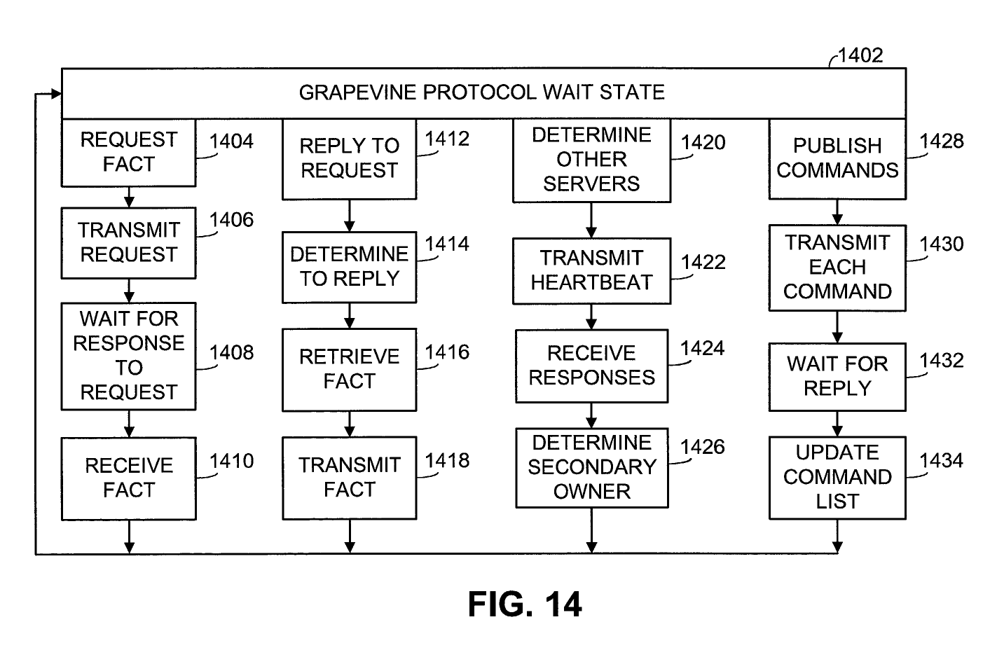

FIGS. 13 and 14 are logic diagrams generally illustrating operations according to the present invention in managing session states across a plurality of server computers. Referring now to FIG. 13, the grapevine protocol (on each server computer/CCMS) remains in a wait state when not performing particular operations (step 1302). The operations of FIG. 13 are performed primarily by the Server Interface Thread(s) 1204 illustrated in FIG. 12, with interaction with other threads as may be required. Upon an access, the grapevine protocol may be requested to create a fact (step 1304). Upon such a create fact request, the grapevine protocol generates a FactID (step 1308), interacts with the requesting process to generate the fact and writes the fact to a fact container (step 1308). During this operation, the grapevine protocol also creates an entry in the FactArray 1152 corresponding to the FactID. Finally, the grapevine protocol adds a command to the command list that corresponds to the creation of the Fact (step 1310, by the CPT).

The pending commands queue is used to keep a record of commands that have been invoked externally so they can be published. The implementation uses the Command Design Pattern to represent all externally invoked methods in the IFacts object. The top of the Command class hierarchy is the Command abstract class, which is Serializable. There are subclasses to represent add/del/renew/change method invocations. The pendingCommands queue is an instance of the PendingCommands class, which represents a collection of Command objects that need to be published. Everything that is published is a subclass of Command, even though strictly speaking, some other publishable things are not commands. For example, There is a subclass of Command called CommandFyi which is used to broadcast Facts to bring up to speed other server computers that may have been recently booted.

In the described embodiment, the UDP protocol is used to broadcast commands. Since UDP is not reliable, it is necessary for a participant to make sure that at least one other participant received the Command before it considers it to be successfully sent. Once two participants know about a command, we have achieved availability with respect to a single point of failure.

In order to implement this efficiently, the concept of primary and secondary ownership of a Command is employed. A Command is created first by one of the participants. This participant is the primary owner and the primary owner broadcasts the command repeatedly until it receives an echo. Every time the primary owner broadcasts a command from the pendingCommands, it sets its secondary Owner as the ID of the last participant from which it received a broadcast. The subscriber threads check the secondary Owner of all commands received, if they are listed as the secondary owner, and then it echoes the command. The subscriber threads check the primary Owner of all commands received, if they are listed as the primary owner, then it removes the corresponding command from the pendingCommands as this is the expected echo. So, commands are removed from the pendingCommands by the subscriber threads, added to the pendingCommands by client threads and broadcast from the pendingCommands by publisher threads.

The grapevine protocol may be requested to change a fact stored (step 1312). In such case, the grapevine protocol receives a FactID corresponding to the Fact and changes to be made. In response, the grapevine protocol retrieves the Fact (step 1314) and modifies and writes the Fact to its corresponding FactContainer (step 1316). The grapevine protocol then adds a command to the command list that corresponds to the changes made to the Fact (step 1318). In an alternate embodiment of steps 1312-1318, the Grapevine Protocol, instead of modifying an existing Fact, creates a new fact and deletes the corresponding old Fact.

Facts may be deleted by a process invoking the grapevine protocol or by the grapevine protocol itself (step 1320). Facts are removed by invoking facts.del( . . . ), facts.renew( . . . ) or facts.change( . . . ) objects. When a Fact is deleted, the FactArray is updated and the fact container is cleared (step 1322). Then, a corresponding deletion command is added to the command list (step 1324).

Facts are also removed by the garbage collector when their timeToLive expires by invoking factArray.del(index, timeToLive) as will be further described with reference to FIG. 19. This is purely a local operation, the deletion of these facts is not published. As facts are added to the fact array, a timestamp is associated with them. The timestamp is obtained from the Timer class. A configuration parameter called secondsToLive is used to determine how long to keep facts. Another configuration parameter called entriesPerCycle is used to determine how often to run the garbage collector. Whenever an entry is added to the facts array historic information is kept to determine when to run the garbage collector. Garbage collection always happens as a side effect of adding an entry to the facts array. There is no separate thread for this.

When a Fact's time to live has not yet expired but its time to renew has expired, and the Fact is accessed by an external process, the Fact will be renewed (step 1326). In such case, the Fact will be retrieved (step 1328) and its time to renew and time to live FactContainer entries will be modified (step 1330). Then, a corresponding command will be added to the command list for subsequent publishing (step 1332).

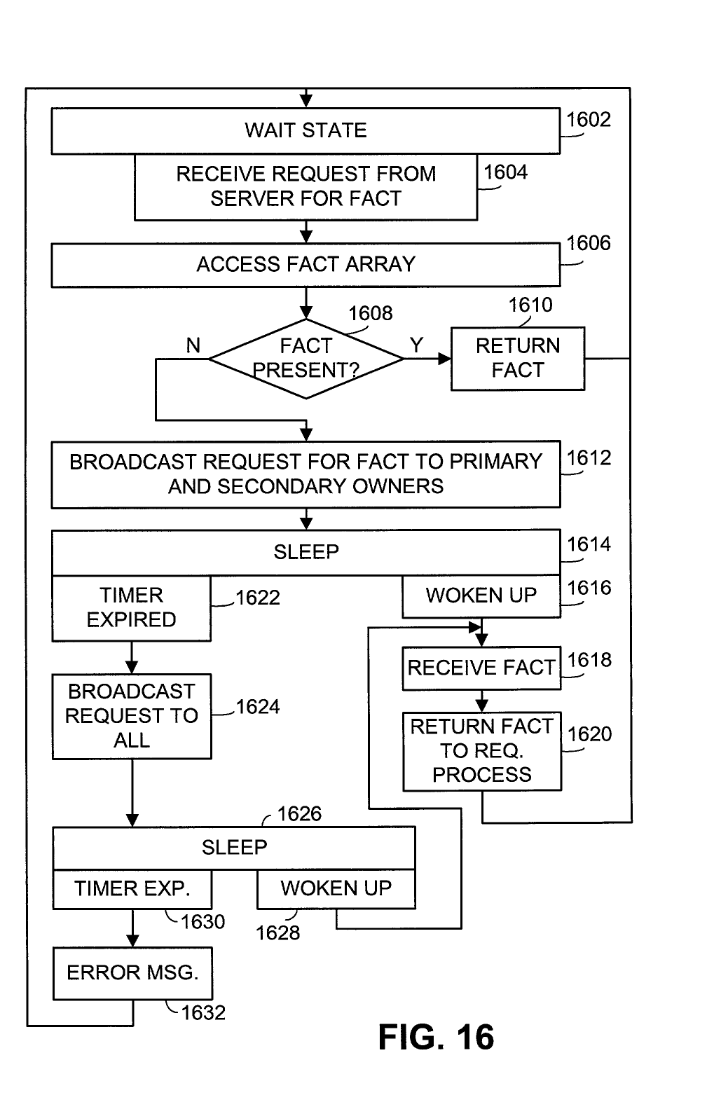

Referring now to FIG. 14, when an external process invokes the grapevine protocol to retrieve a Fact, the grapevine protocol may determine that it does not possess a copy of the requested Fact. In such case, the grapevine protocol publishes a request for the Fact (step 1404) with a GET command that includes the FactID corresponding to the FACT. In such case, the grapevine protocol publishes the request (step 1406) to the primary owner of the Fact and to the secondary owner of the Fact. The grapevine protocol then waits for a response (step 1408) and receives the fact (step 1410). If the primary and secondary owners do not responds to the request, a request may then be broadcast to all other active server computers running instances of the grapevine protocol. This particular set of operations will be discussed further with reference to FIG. 16.

According to one embodiment of the operations of steps 1404-1410, when a participant has a FactId and cannot find the corresponding fact in its fact array, it broadcasts a CommandQuery or GET command. When a subscriber receives a CommandQuery GET with a FactId, if it can find the corresponding factContainer and if it is marked as the primary or secondary owner it broadcasts the corresponding CommandReply. If the participant that issued the CommandQuery does not get a reply in a certain amount of time, then it issues a CommandQuery GET with a flag indicating a reply from any participant is welcome. Upon receiving such a command, any subscriber that can find the factContainer should send a CommandReply. Currently CommandReply objects are broadcasted even though potentially only one participant is interested in the answer.

An instance of the grapevine protocol may respond a request to provide a Fact (step 1412). In such case, the grapevine protocol determines that it should reply (step 1414), retrieves the fact (step 1416) and transmits the fact to the requesting instance of the grapevine protocol (step 1418). As was previously discussed, if the server computer is the primary owner or the secondary owner, it will be first requested to provide a copy of the fact. If the server computer is not the primary or secondary owner, it still may be requested to provide the fact if the primary and secondary owner do not respond to an earlier request to provide a copy of the Fact.

Each particular instance of the grapevine protocol (running on a server computer) that operates in conjunction with other instances of the grapevine protocol (running on other server computers) requires knowledge of the existence of the other server computers. Thus, the grapevine protocol periodically determines the existence of the other server computers (step 1420). In such case, the server computer broadcasts a heartbeat message to all other server computers that may potentially operate in conjunction with the server computer (step 1422). The server computer then receives responses from the other server computers (step 1424). In this operation, the server computer determines a “secondary owner” that it will use until it enacts another set of operations according to steps 1420 through 1426. The secondary owner is the last server computer that responds to the heartbeat.

Periodically, the server computer publishes the commands that it has queued in the command list (step 1428). The server computer transmits each command in its command list, identifying itself as the primary owner and also identifying the secondary owner (step 1430). The server computer then waits for a reply to the transmission of each command (step 1432). If a reply is received, the corresponding command is removed from the command list (step 1434).

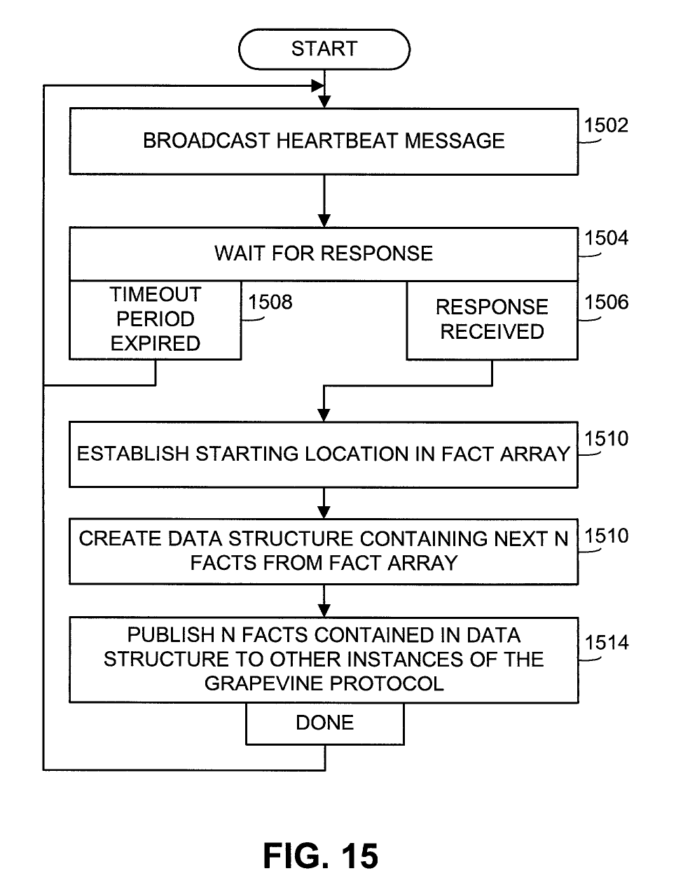

FIG. 15 is a logic diagram illustrating operation according to the present invention in publishing facts contained in a fact array to other server computers. The operations of FIG. 15 are performed primarily by the Fact Publisher Thread 1210 1212 of FIG. 12. Operation commences wherein the Command Publisher Thread 1208 broadcasts a heartbeat (step 1502). The grapevine protocol then enters a wait state, waiting for the response (step 1504). If, after a timeout period expires and no response has been received, operation returns to step 1502 wherein the Command Publisher Thread 1208 broadcasts another heartbeat.

However, if a response is received from at least one other instance of the Grapevine Protocol (step 1506), the Fact Publisher Thread 1210 commences its Fact publishing operations by establishing a starting point in the FactArray at which to broadcast facts (step 1510). Each instance of the Grapevine Protocol includes a FPT, with each instance of the Fact Publisher Thread 1210 publishing contents of its coupled FactArray. Because similarity exists in the contents of each instance of the FactArray, benefits are obtained by having each instance of the Fact Publisher Thread 1210 broadcast facts from differing portions of the FactArrays. Thus, at steep 1510, the Fact Publisher Thread 1210 selects a location within the FactArray that separates its publishing location from the publishing locations of other instances of the FPT. The Fact Publisher Thread 1210 determines this spaced location based upon the broadcasted facts received by the Subscriber Thread(s) 1206 from other instances of the FPT.

With the starting location in the FactArray determined by the FPT, the Fact Publisher Thread 1210 creates a data structure that contains a copy of the next N Facts in the FactArray beginning at the starting location (step 1512). The Fact Publisher Thread 1210 then publishes these next N facts to other instances of the Grapevine Protocol (step 1514). When the operation is complete, operation returns to step 1502. In another embodiment, operation proceeds to step 1504.

FIG. 16 is a logic diagram illustrating operation according to the present invention in servicing a request for a Fact from another process operating upon a server computer. The Server Interface Thread(s) 1204 remains in a wait state (step 1602) until a request from another process on the server computer for the Fact is received at the HTTP port (step 1604). When the request is received, the Server Interface Thread(s) 1204 first accesses the FactArray to determine whether a copy of the Fact exists in the FactArray (step 1606). If a copy of the Fact is present, and it has not expired (as determined at step 1608), the Fact is accessed and returned to the requesting process via the HTTP port by the Server Interface Thread(s) 1204 (step 1606). Operation then proceeds to the wait state of FIG. 1602.

If the Fact is not present in the FactArray 1212, as determined at step 1608, the Server Interface Thread(s) 1204 broadcasts a GET command for the Fact to the primary and secondary owners of the Fact (step 1612). The Server Interface Thread(s) 1204 then enters a sleep mode (step 1614). While the Server Interface Thread(s) 1204 is asleep, the Subscriber Thread(s) 1206 may receive a copy of the Fact from the primary or secondary owner of the Fact, in which case the Subscriber Thread(s) 1206 populates the FactArray with the Fact and wakes up the Server Interface Thread(s) 1204 (step 1616). The Server Interface Thread(s) 1204 then accesses the Fact from the FactArray (step 1618) and returns the Fact to the requesting process. In an alternate embodiment, the Subscriber Thread(s) 1206 returns a copy of the Fact to the Server Interface Thread(s) 1204 directly. In this alternate embodiment, either the Server Interface Thread(s) 1204 or the Subscriber Thread(s) 1206 may update the FactArray.

If the Server Interface Thread(s) 1204 is not woken up from its sleep cycle of step 1614, a sleep timer will expire (step 1622). In response to the expiration of the sleep timer, the Server Interface Thread(s) 1204 will broadcast a GET command to all other instances of the Grapevine Protocol running on a group of server computers (step 1624). The Server Interface Thread(s) 1204 will then enter another sleep cycle (step 1626). The Subscriber Thread(s) 1206 may wake the Server Interface Thread(s) 1204 up from this sleep cycle if the Subscriber Thread(s) 1206 receives a copy of the requested Fact (step 1628). If the Subscriber Thread(s) 1206 wakes up the Server Interface Thread(s) 1204 at step 1628, operation proceeds to step 1618. If a sleep timer expires without the Subscriber Thread(s) 1206 waking up the Server Interface Thread(s) 1204 (step 1630), the Server Interface Thread(s) 1204 will return an error message to the requesting process (step 1632) and return to the wait state of step 1602.

FIG. 17 is a logic diagram illustrating operation according to the present invention in servicing communications received at a broadcast port. Primarily the Subscriber Thread(s) 1206 performs these operations. The subscriber thread, on one operation, waits for commands and other information to be received at the B/C port (step 1702). One of the items that may be received is a Fact that is received in response to a GET command that was broadcast by the Server Interface Thread(s) 1204 (step 1704). In such case, the Subscriber Thread(s) 1206 updates the FactArray (step 1706) and then notifies (wakes up) the Server Interface Thread(s) 1204 that was waiting for the response (step 1708).

The Subscriber Thread(s) 1206 may also receive a heartbeat receipt in response to a heartbeat request sent by the Command Publisher Thread 1208 (step 1710). In such case, the Subscriber Thread(s) 1206 sets the alone flag to false, indicating that other instances of the Grapevine Protocol exist on other server computers (step 1712). The Subscriber Thread(s) 1206 also may determine a secondary owner based upon the heartbeat response (step 1714). As a general proposition, however, anytime that the Subscriber Thread(s) 1206 receives a communication on the B/C port, the Subscriber Thread(s) 1206 may determines that a corresponding source process is the current secondary owner.

The Subscriber Thread(s) 1206 may receive a Fact that was broadcast by Fact Publisher Thread 1210 operated by another instance of the Grapevine Protocol (step 1716). In such case, the Subscriber Thread(s) 1206 updates its coupled FactArray based upon the received Fact, if required (step 1718).

The Subscriber Thread(s) 1206 also receives commands on the B/C port (step 1720). These commands were discussed with reference to FIG. 13. When the Subscriber Thread(s) 1206 receives a command at the B/C port, it first determines whether it is the primary owner (step 1722). If it is the primary owner of the command, then the command has been broadcast by the coupled Command Publisher Thread 1208 and has been echoed by another instance of the Grapevine Protocol. In such case, the Subscriber Thread(s) 1206 directs the Command Publisher Thread 1208 to remove the corresponding command from the command queue because the command has been received by another instance of the Grapevine Protocol. If the Subscriber Thread(s) 1206 is not the primary owner of the command, the Subscriber Thread(s) 1206 identifies the Fact to be operated upon and the type of command to be performed, e.g., add, delete, renew, change, etc. (step 1726). The Subscriber Thread(s) 1206 then executes the command and updates the FactArray accordingly (step 1728).

FIG. 18 is a logic diagram illustrating operation according to the present invention in performing garbage collection of the FactArray. The garbage collector waits to initiate its operation (step 1802) until a new Fact is added to the FactArray (step 1804). The garbage collector considers the oldest Fact in the FactArray first (step 1806). If the oldest Fact in the FactArray first should be deleted, as determined at step 1808, the fact is deleted (step 1810). Then, the garbage collector considers the next oldest Fact (step 1812) and returns to step 1808. If the first Fact considered is not to be deleted, operation returns to step 1802.

The following description considers one embodiment of the present invention. In the embodiment, a publisher thread broadcasts 2 types of Commands, those that are in the pendingCommand queue as a result of a external method invocation and the CommandFyi objects that are obtained from the array of Facts. Commands are published using the following algorithm:

Loop forever:

If I am alone, sleep for a period of time and send a heartbeat command to let others know I am alive.

If I am not alone, broadcast all the commands in pendingCommands. As part of the broadcast, set secondaryOwner=lastParticipant for each command sent. Don't remove anything from pendingCommands, they are deleted by the subscriber thread.

//TU=timeUnit used (probably seconds) networkRate=(totalPerTU−totalSeenLastTU)/totalParticipantsLastTU; publishSleepInterval=(TUsPerSec*1000)/networkRate; System.sleep(publishSleepInterval);

getNextFactContainerToSend( )

send the factContainer wrapped inside a CommandFyi object.

The algorithm for getNextFactContainerToSend( ) is: decrement the factToSendIndex by 1

factToSend<oldestFact recalculate factToSend by finding the largest interval between all known participants and setting factToSend=(minlargestIntervalIndex+maxLargestInterval)/2 return factToSend

TotalPerTU is a system-wide configuration parameter that indicates how many facts we want to broadcast per time unit from all participants. You can see that participants are fair about splitting up the work, except that things in the publisher queue are broadcast without delay. The publisherSleepInterval is calculated to fill up the time by publishing facts.

A subscriber performs the following operations in waiting for commands from a publisher in one embodiment of the grapevine protocol:

Loop forever:

Read packet from broadcast port. Thread blocks until a packet is available.

Deserialize the Command object received and invoke its dolt method. Command objects know their expected behavior. This is encoded in their execute( ) method which is invoked by the dolt method. Command objects know that part of what they have to do is echo the Command to the grapevine if they are the secondaryOwner. They also know that if they are the primaryOwner they should delete the corresponding Command from the pendingCommands.

Also, according to the described embodiment, the following API is invoked:

public abstract class Facts implements IFacts {

/**
* Returns an instance of IFacts configured as

* stated

* in the configFile property file.
*/
public static IFacts forFile(

String configFile

) throws GrapevineException;

}

There is also an interface called IFacts, you get an instance by invoking Facts.forFile( ):

public interface IFacts {

/**
* Returns the fact with the given factId, or

* null if none exists.

* This may happen if the fact died or if the

* factId is incorrect.

* If the fact is not in the local cache, then

* the API may block

* after requesting its peers to transmit the

* fact.

*/

Object get(FactId factId) throws GrapevineException;

/**
* Returns the FactId assigned to the new fact.

* The fact is placed

* in the publishing queue, but the API returns

* before the fact is

* transmitted. The number of seconds to live

* and to renew are set

* to their default values.
*/

FactId add(Object fact) throws GrapevineException;

/**
* Returns the FactId assigned to the new fact.

* The fact is placed

* in the publishing queue, but the API returns

* before the fact is

* transmitted.
*/
FactId add(

Object fact,
int secondsToLive,
int secondsToRenew

) throws GrapevineException;
/**
* Touches the fact associated with FactId and

* returns the

* newly assigned FactId. When a fact is

* renewed, if that fact was

* below its low water mark, then a new FactId is

* assigned so it

* won't expire and the old factid is deleted.

* If the

* fact is not below the low water mark, then

* renew() returns the

* same FactId provided as an argument and does

*nothing.

* The fact, if provided, is used to ensure that

* if

* get succeeds, then renew also succeeds, even
* if the entry is garbage collected in the

* meantime. If the fact

* is renewed, the number of seconds to live and

* to renew are set

* to their default values.
*
* @throws TooLateException If fact is null and

* the entry

* has already been garbage collected.
*/

renew(FactId factId, Object fact) throws GrapevineException;

/**
* Touches the fact associated with factId and

* returns the

* newly assigned FactId. When a fact is

* renewed, if that fact was

* below its low water mark, then a new FactId is

* assigned so it

* won't expire and the old factId is deleted.

* If the

* fact is not below the low water mark, then

* renew() returns the

* same factId provided as an argument and does

* nothing.

*
* The fact, if provided, is used to ensure that

* if

* get succeeds, then renew also succeeds, even
* if the entry is garbage collected in the

* meantime.

*
* @throws TooLateException If fact is null and

* the entry

* has already been garbage collected.
*/
FactId renew(

FactId factId,
Object fact,
int secondsToLive,
int secondsToRenew

) throws GrapevineException;
/**
* Similar to an atomic add and del, It deletes
* the factId and adds the new fact. The number
* of seconds to live and to renew for the new

* fact are set to

* their default values. Since grapevine facts

* are immutable, this

* method can be used when a fact changes value

* to delete the old

* grapevine fact and add a new one.
*/

change(FactId factId, Object fact) throws GrapevineException;

/**
* Similar to an atomic add and del, It deletes
* the factId and adds the new fact. The number
* of seconds to live and to renew for the new

* fact are set based

* on <secondsToLive and secondsToRenew. Since
* grapevine facts are immutable, this method can

* be used when a

* fact changes value to delete the old grapevine

* fact and add a

* new one.
*/
FactId change(

FactId factId,
Object fact,
int secondsToLive,
int secondsToRenew

) throws GrapevineException;
/**
* Deletes the fact associated with factId and

* returns the

* deleted fact; returns null if factId does not
* exist.
*/

Object del(FactId factId) throws GrapevineException;

/**
* Flushes the publishing queue before it

* returns. This method

* should be invoked before the server computer is taken

* off-line. No other

* threads should add facts.
*/
void flush() throws GrapevineException;
/**
* Close this instance. Once this method is

* invoked, no other

* methods (except close()) should be invoked on

* this object.

* close() invokes flush() closes the network

* connection if any and

* releases the cache and other objects held on

* by this object.

*/
void close();

```
    }
  Finally, there is a class to represents FactIds:
public final class FactId implements Comparable, Serializable {
```

// producers --------------------------------------------------
public static FactId forLong(long id);
public static FactId forHexString(String id);
// conversion methods ----------------------------------------
public final long toLong();
public final String toHexString();

}

The invention disclosed herein is susceptible to various modifications and alternative forms. Specific embodiments therefore have been shown by way of example in the drawings and detailed description. It should be understood, however, that the drawings and detailed description thereto are not intended to limit the invention to the particular form disclosed, but on the contrary, the invention is to cover all modifications, equivalents and alternatives falling within the spirit and scope of the present invention as defined by the claims.

1. A method for operating a server computer as part of a group of server computers to maintain session states for a plurality of users, the method comprising:
creating a first session state and locally storing the session state;
transmitting a command to the group of server computers that, when executed by an executing server computer of the group of server computers, causes the executing server computer to locally store the first session state;
receiving a command from another server computer of the group of server computers that corresponds to a second session state; and
executing, by the server computer, the command to create the second session state and to locally store the second session state.

2. The method of claim 1, further comprising:
receiving a request for a third session state from a locally coupled process;
determining that the third session state is not locally stored; and
requesting the third session state from at least one other server computer.

3. The method of claim 2, further comprising:
identifying a primary owner and a secondary owner of the third session state; and
transmitting a request for the third session state to the primary owner and the secondary owner of the session state.

4. The method of claim 2, wherein the request for the third session state is broadcast to all other server computers of the group of server computers.

5. The method of claim 1, further comprising:
receiving a request from a coupled process to modify the first session state;
modifying a local copy of the first session state; and
broadcasting a command to other server computers of the group of server computers that, when executed by an executing server computer, causes the executing server computer to locally modify the first session state.

6. The method of claim 5, wherein modifying the local copy of the first session state includes:
deleting the local copy of the first session state; and
creating a new copy of the first session state with modifications included therein.

7. The method of claim 1, wherein the local copy of the first session state is stored in dynamic memory of the server computer.

8. The method of claim 1, wherein the local copy of the first session state is stored in static memory of the server computer.

9. The method of claim 1, further comprising:
deleting the local copy of the first session state; and
creating a new copy of the first session state with modifications included therein.

10. The method of claim 1, further comprising:
deleting the local copy of the first session state; and
broadcasting a command to other server computers of the group of server computers that, when executed by an executing server computer, causes the executing server computer to locally delete the first session state.

11. The method of claim 1, further comprising:
renewing the local copy of the first session state; and
broadcasting a command to other server computers of the group of server computers that, when executed by an executing server computer, causes the executing server computer to locally renew the first session state.

12. The method of claim 1, further comprising:
receiving a request for a requested session state from a requesting server computer of the group of server computers;
accessing a local copy of the requested session state; and
transmitting a copy of the requested session state to the requesting server computer.

13. The method of claim 12, where in:
the request is sent to the primary owner and secondary owner of the requested session state; and
the server computer is the primary owner or secondary owner of the requested session state.

14. The method of claim 12, wherein the request is sent to all server computers of the group of server computers.

15. The method of claim 1, further comprising identifying at least one other server computer of the group of server computers.

16. The method of claim 1, further comprising identifying a secondary owner of the other server computers of the group of server computers.

17. The method of claim 1, further comprising publishing a plurality of locally stored session states to other server computers of the group of server computers.

18. The method of claim 17, wherein the server computer coordinates the session states it publishes with session states published by other server computers of the group of server computers.

19. A system for operating a server computer as part of a group of server computers to maintain session states for a plurality of users, the system comprising:
a fact array that locally stores a plurality of session states on the server computer;
a server computer interface thread that couples the fact array, to at least one local and to a broadcast port, wherein the server computer interface thread creates a first session state and locally stores the session state in the fact array;
a command publisher thread coupled to the server computer interface thread and to the broadcast port that transmits a command to the group of server computers that, when executed by an executing server computer of the group of server computers, causes the executing server computer to locally store the first session state;
a subscriber thread coupled to the fact array, the server computer interface thread, the command publisher thread, and the broadcast port, wherein the subscriber thread receives a command from another server computer of the group of server computers that corresponds to a second session state; and
wherein the subscriber thread executes the command to create the second session state and to locally store the second session state in the fact array.

20. The system of claim 19, wherein:
the command publisher thread transmits a request to determine whether the server computer is the only member of the group of server computers; and
the subscriber thread receives at least one response to determine whether the server computer is the only member of the group of server computers.

21. The system of claim 19, wherein:
the subscriber thread further determines a secondary owner of the group of server computers; and
the subscriber thread notifies the command publisher thread of the identity of the secondary owner.

22. The system of claim 19, wherein:
the server computer interface thread receives a request for a third session state from a locally coupled process;
the server computer interface thread determines that the third session state is not locally stored; and
the server computer interface thread requests the third session state from at least one other server computer.

23. The system of claim 22, wherein the server computer interface thread transmits the request for the third session state to the primary and secondary owners of the third session state.

24. The system of claim 22, wherein the server computer interface thread broadcasts the request for the third session state to all other server computers of the group of server computers.

25. The system of claim 19, wherein:
the subscriber interface thread receives a request from a coupled process to modify the first session state;
the subscriber interface thread modifies a local copy of the first session state stored in the fact array; and
the command publisher thread broadcasts a command to other server computers of the group of server computers that, when executed by an executing server computer, causes the executing server computer to locally modify the first session state.

26. The system of claim 25, wherein in modifying the local copy of the first session state:
the server computer interface thread deletes the local copy of the first session state from the fact array; and
the server computer interface thread creates a new copy of the first session state with modifications included therein in the fact array.

27. The system of claim 19, wherein the fact array is at least partially created in dynamic memory of the server computer.

28. The system of claim 19, wherein the fact array is at least partially created in static memory of the server computer.

29. The system of claim 19, wherein:
the server computer interface thread deletes the local copy of the first session state from the fact array; and
the server computer interface thread creates a new copy of the first session state in the fact array with modifications included therein.

30. The system of claim 19, wherein:
the server computer interface thread deletes the local copy of the first session state from the fact array; and
the command publisher thread broadcasts a command to other server computers of the group of server computers that, when executed by an executing server computer, causes the executing server computer to locally delete the first session state.

31. The system of claim 19, wherein:
the server computer interface thread renews the local copy of the first session state stored in the fact array; and
the command publisher thread broadcasts a command to other server computers of the group of server computers that, when executed by an executing server computer, causes the executing server computer to locally renew the first session state.

32. The system of claim 19, wherein:
the subscriber interface thread receives a request for a requested session state from a requesting server computer of the group of server computers;
the command publisher thread accesses a local copy of the requested session state stored in the fact array; and
the command publisher thread transmits a copy of the requested session state to the requesting server computer.

33. The system of claim 32, wherein:
the request is sent to the primary owner and secondary owner of the requested session state; and
the server computer is the primary owner or secondary owner of the requested session state.

34. The system of claim 32, wherein the request is sent to all server computers of the group of server computers.

35. The system of claim 19, wherein the subscriber thread identifies at least one other server computer of the group of server computers.

36. The system of claim 19, wherein the subscriber thread identifies a secondary owner of the other server computers of the group of server computers.

37. The system of claim 19, further comprising a fact publisher thread coupled to the fact array that publishes a plurality of locally stored session states to other server computers of the group of server computers.

38. The system of claim 37, wherein the fact publisher thread coordinates the session states it publishes with session states published by other server computers of the group of server computers.

39. A server computer operated as part of a group of server computers to maintain session states for a plurality of users, the server computer comprising:
a processor coupled to a processor bus;
dynamic memory coupled to the processor via the processor bus;
static memory coupled to the processor via the processor bus
an interface coupled to the processor bus that interfaces the server computer to a computer network; and
the memory storing a set of instructions executable by the processor, the set of instructions comprising:
a plurality of instructions that, upon execution by the processor, cause the server computer to create a first session state and locally store the session state;
a plurality of instructions that, upon execution by the processor, cause the server computer to transmit a command to the group of server computers that, when executed by an executing server computer of the group of server computers, causes the executing server computer to locally store the first session state;
a plurality of instructions that, upon execution by the processor, cause the server computer to receive a command from another server computer of the group of server computers that corresponds to a second session state; and
a plurality of instructions that, upon execution by the processor, cause the server computer to create the second session state and to locally store the second session state.

40. The server computer of claim 39, wherein the set of instructions further comprise:
a plurality of instructions that, upon execution by the processor, cause the server computer to receive a request for a third session state from a locally coupled process;
a plurality of instructions that, upon execution by the processor, cause the server computer to determine that the third session state is not locally stored; and
a plurality of instructions that, upon execution by the processor, cause the server computer to request the third session state from at least one other server computer.

41. The server computer of claim 40, further comprising:
a plurality of instructions that, upon execution by the processor, cause the server computer to identify a primary owner and a secondary owner of the third session state; and
a plurality of instructions that, upon execution by the processor, cause the server computer to transmit a request for the third session state to the primary owner and the secondary owner of the session state.

42. The server computer of claim 40, wherein the server computer broadcasts the request for the third session state to all other server computers of the group of server computers.

43. The server computer of claim 39, wherein the set of instructions further comprise:
a plurality of instructions that, upon execution by the processor, cause the server computer to receive a request from a coupled process to modify the first session state;
a plurality of instructions that, upon execution by the processor, cause the server computer to modify a local copy of the first session state; and
a plurality of instructions that, upon execution by the processor, cause the server computer to broadcast a command to other server computers of the group of server computers that, when executed by an executing server computer, causes the executing server computer to locally modify the first session state.

44. The server computer of claim 43, wherein modifying the local copy of the first session state includes:
deleting the local copy of the first session state; and
creating a new copy of the first session state with modifications included therein.

45. The server computer of claim 39, wherein the local copy of the first session state is stored in the dynamic memory of the server computer.

46. The server computer of claim 39, wherein the local copy of the first session state is stored in the static memory of the server computer.

47. The server computer of claim 39, wherein the set of instructions further comprise:
a plurality of instructions that, upon execution by the processor, cause the server computer to delete the local copy of the first session state; and
a plurality of instructions that, upon execution by the processor, cause the server computer to create a new copy of the first session state with modifications included therein.

48. The server computer of claim 39, wherein the set of instructions further comprise:
a plurality of instructions that, upon execution by the processor, cause the server computer to delete the local copy of the first session state; and
a plurality of instructions that, upon execution by the processor, cause the server computer to broadcast a command to other server computers of the group of server computers that, when executed by an executing server computer, causes the executing server computer to locally delete the first session state.

49. The server computer of claim 39, wherein the set of instructions further comprise:
a plurality of instructions that, upon execution by the processor, cause the server computer to renew the local copy of the first session state; and
a plurality of instructions that, upon execution by the processor, cause the server computer to broadcast a command to other server computers of the group of server computers that, when executed by an executing server computer, causes the executing server computer to locally renew the first session state.

50. The server computer of claim 39, wherein the set of instructions further comprise:
a plurality of instructions that, upon execution by the processor, cause the server computer to receive a request for a requested session state from a requesting server computer of the group of server computers;
a plurality of instructions that, upon execution by the processor, cause the server computer to access a local copy of the requested session state; and
a plurality of instructions that, upon execution by the processor, cause the server computer to transmit a copy of the requested session state to the requesting server computer.

51. The server computer of claim 50, wherein:
the request is sent to the primary owner and secondary owner of the requested session state; and
the server computer is the primary owner or secondary owner of the requested session state.

52. The server computer of claim 50, wherein the request is sent to all server computers of the group of server computers.

53. The server computer of claim 39, wherein the set of instructions further comprise
a plurality of instructions that, upon execution by the processor, cause the server computer to identify at least one other server computer of the group of server computers.

54. The server computer of claim 39, wherein the set of instructions further comprise
a plurality of instructions that, upon execution by the processor, cause the server computer to identify a secondary owner of the other server computers of the group of server computers.

55. The server computer of claim 39, wherein the set of instructions further comprise
a plurality of instructions that, upon execution by the processor, cause the server computer to publish a plurality of locally stored session states to other server computers of the group of server computers.

56. The server computer of claim 55, wherein the server computer coordinates the session states it publishes with session states published by other server computers of the group of server computers.
